(19) United States
(12) Patent Application Publication
(10) Pub. No.: US 2023/0179054 A1
(43) Pub. Date: Jun. 8, 2023

(54) STATOR HAVING WAVE-WINDING COIL STRUCTURE, THREE-PHASE AC MOTOR EQUIPPED WITH SAME, AND METHOD FOR PRODUCING STATOR

(71) Applicant: FANUC CORPORATION, Yamanashi (JP)

(72) Inventor: Takashi ITO, Yamanashi (JP)

(21) Appl. No.: 17/997,246

(22) PCT Filed: Apr. 22, 2021
(86) PCT No.: PCT/JP2021/016335

§ 371 Date: Oct. 27, 2022

(30) Foreign Application Priority Data
Apr. 28, 2020 (JP) 2020-079420

(51) Int. Cl. H02K 3/28; H02K 15/085; H02K 1/18; H02K 3/12

(52) U.S. Cl. CPC H02K 3/28; H02K 15/085; H02K 1/18; H02K 3/12

(57) ABSTRACT

A distributed winding coil structure for automatic winding in a fractional slot three-phase AC motor has a stator in which the slot number 6N (N is a positive integer) of the slots positioned in the circumferential direction is greater than 1.5 times the pole number 2P (P is a positive integer), and the value obtained by dividing the slot number 6N by the pole number 2P is an irreducible fraction. Six coil groups are provided which include coils positioned in a wave winding inside a slot at a slot pitch of X or X+1, if the quotient obtained by dividing the slot number 6N by the pole number 2P is X (X is a positive integer), and each of the six coil groups is positioned so as to be offset by 60 degrees in the circumferential direction.

### TECHNICAL FIELD

The present invention relates to a stator having a coil structure of wave winding, a three-phase AC motor including the same, and a method for manufacturing a stator.

### BACKGROUND ART

Conventionally, a three-phase AC motor including a fractional slot in which the value obtained by dividing the number of slots by the number of poles takes an irreducible fraction, as a combination of poles and slots that can reduce the cogging torque and the torque ripple of the three-phase AC motor, is known. Such a three-phase AC motor is also called a “fractional-slot three-phase AC motor.”

In the three-phase AC motor including a fractional slot, since the number of poles and the number of slots can be selected to set the least common multiple of the number of poles and the number of slots large, and the value of a high-order distributed winding factor can be set small, the torque ripple can be reduced.

In a three-phase AC motor including a fractional slot in which the number of slots is larger than 1.5 times the number of poles, the torque ripple is more likely to be small, but the slot pitch of windings inserted into the slots is higher than one slot (the distance between adjacent slots), and a coil structure of distributed winding is therefore involved.

Methods of distributed winding are roughly classified into three types: lap winding, concentric winding, and wave winding. Of these types of winding, wave winding refers to a method for bending an annular coil spanning 360 degrees in a wave shape, and winding the coil around slots of a stator. In wave winding, since fewer crossover lines are connected between the coils, coil ends (the ends of the coil that are not accommodated in the stator) can even be advantageously formed small.

In the three-phase AC motor including a fractional slot, the number of poles defined by an even number and the number of slots defined by a multiple of three can be selected from arbitrary values. Therefore, the number of slots can even be selected to take a small value relative to the selected number of poles. Selecting the number of poles and the number of slots to set the slot pitch low makes it possible to shorten the circumferential length of the coil ends of each coil and thus form these coil ends small. As a result, the motor can be downsized, and an effect of reducing the copper loss of the coils is also produced.

In the three-phase AC motor including a fractional slot, however, lap winding of a double-layer winding structure having a mixture of windings of two phases is generally formed per slot in specific slots. In lap winding, the coil ends of two arbitrary adjacent coils align themselves parallel to each other. Therefore, two or more ring-shaped coils overlap each other in an arbitrary radial direction from the center of the stator toward the outer circumference of the stator, thus forming full circle winding. Therefore, an operation for interchanging some coils is involved in inserting the coils into the stator. In other words, it is difficult to automatically insert the coils into the stator, using, e.g., an inserter automatic winding machine in the manufacture of the motor. In the three-phase AC motor including a fractional slot, it is desired to establish a manufacturing method that allows easy automatic winding.

In the three-phase AC motor including a fractional slot, further, since the value obtained by dividing the number of slots by the number of poles takes no integer, the number of slots of a stator corresponding to one magnetic pole does not match the period of the magnetic poles. Due to the mismatch in periodicity, therefore, winding around all slots not by lap winding, but only by wave winding involves three or more annular coils per phase, involves a plurality of ring-shaped small coils because annular coils alone may not be allowed to occupy all the slots, involves a plurality of crossover lines to connect individual coils to each other, or involves a process of shaping for twisting parts of annular coils of wave winding.

In, e.g., a three-phase AC motor including a rotor having a plurality of pairs of magnetic poles, a stator including a plurality of slots formed to extend in a direction of an axis of rotation of the rotor and aligned in a circumferential direction, the stator facing the rotor in a radial direction, and a plurality of windings inserted into the slots and wound on the stator, a three-phase AC motor is known in which letting 2P be the number of poles on the rotor, and N be the number of slots to insert the windings of the stator, a value obtained by dividing the number of slots N by the number of pole pairs P takes no integer, and letting X be a quotient of the number of slots N of the stator divided by the number of poles 2P, the stator includes a first annular winding portion in which one coil having a diameter larger than an inner diameter of the stator and wound with a predetermined number of turns is wound by wave winding at a slot pitch of X or X+1 in a winding of each phase, and which is mounted in the slots to span 360 degrees in the circumferential direction, a second annular winding portion in which one coil is wound by wave winding at a slot pitch of X or X+1, like the first annular winding portion, and which is mounted in the slots to span 360 degrees in the circumferential direction to be shifted to a position that does not completely overlap a position of the first annular winding portion from the first annular winding portion in the circumferential direction, and a plurality of third winding portions which have windings wound to span two slots and are mounted in the slots, and the first annular winding portion, the second annular winding portion, and the plurality of third winding portions are connected in series with each other for each phase (see, e.g., PTL 1).

In, e.g., a fractional-slot-winding three-phase armature winding of double-layer lap winding in which the number of slots q per pole per phase is represented as q=A+B/C (where A is an integer of 1 or more, B is a positive integer, C=4, 5, 7, and 8, and B/C is an irreducible fraction), a three-phase armature winding is known in which all phase belts are divided into groups of windings each having C continuous phase belts, one of the coils belonging to each group of windings is split into two coils each having conductors, the number of which is about a half the number of conductors of each remaining coil, the two coils are distributed to two adjacent phase belts, and the split coils are distributed in a parallel circuit (see, e.g., PTL 2).

A vehicle AC generator, for example, is known that includes a stator including a stator core in which a plurality of slots are formed, and a stator winding formed by a plurality of conductors accommodated in each of the plurality of slots, and a rotor that has a plurality of magnetic poles arranged to alternately differ in polarity in a rotation direction, and is mounted with a gap between the rotor and the stator, wherein the plurality of conductors arranged to span three adjacent slots of the slots and to skip the plurality of slots in correspondence with the plurality of magnetic poles are electrically connected to each other to form a phase winding of one phase, the phase winding includes several phase windings forming one multiphase winding, the multiphase winding includes multiphase windings having an equal number of turns, the multiphase windings are electrically connected in parallel with each other, and the phase winding is formed by five conductors of the conductors for each of the magnetic poles (see, e.g., PTL 3).

A motor stator, for example, is known that includes winding guide means mounted on side surfaces of a stator core in an axial direction, i.e., at coil end portions of the stator, and a stator winding that is formed by winding a U-phase winding among a U phase, a V phase, and a W phase in a case of a three-phase motor at a position, at which entrances of coil end faces of slots for the V phase and the W phase are not occupied, by guiding the U-phase winding by the winding guide means at the coil end portion of the U-phase winding through a slot in the stator, winding a V-phase winding at a position at which the entrance of the coil end face of the slot for the W phase remaining to be used for winding is not occupied, like the U-phase winding, and winding a W-phase winding so that the coil end portion of the W-phase winding overlaps the coil end portions of the U-phase winding and the V-phase winding to set a length of an electric wire at the coil end portion of the W phase as small as possible (see, e.g., PTL 4).

In, e.g., a wave-wound winding for a three-phase rotating electrical machine in which a plurality of helically-wound sheet-like coils each having coil conductors helically connected to each other and wound in a wave winding configuration are stacked on each other in a sheet thickness direction and electrically connected to each other, the coil conductors each having coil side portions alternately inserted into slots in a stator core, and a coil end portion that is formed integrally with the coil side portions and connects end portions of the coil side portions on an identical side to each other, a wave-wound winding for a three-phase rotating electrical machine is known in which the helically-wound sheet-like coils adjacent to each other in the sheet thickness direction are shifted from each other in a moving direction of a movable element magnetic pole, and phase coils of an identical phase are connected in series with each other between the helically-wound sheet-like coils (see, e.g., PTL 5).

In, e.g., a rotating electrical machine including an armature core including a plurality of teeth aligned in a circumferential direction, and an armature winding formed by m-phase windings (m is a positive integer) disposed in slots between the teeth by distributed winding, a rotating electrical machine is known in which the m-phase windings are divided into two groups: a first group of m-phase windings and a second group of m-phase windings, positions of start of winding of conducting wires of the respective phases forming the first group of m-phase windings are respectively set in a first slot to an mth slot, positions of start of winding of conducting wires of the respective phases forming the second group of m-phase windings are respectively set in an (m+1)th slot to a 2mth slot, the conducting wires are wound in a wave shape in the circumferential direction of the armature core from the start of winding of each conducting wire for each of the groups of m-phase windings, and upon setting a side on which the slot opens in a radial direction of the armature core as a slot top side, and a side opposite to the side on which the slot opens in the radial direction as a slot bottom side, when the slot bottom side is defined as a first layer at a winding position in the slot, and the slot top side is defined as a second layer at the winding position, the first group of m-phase windings and the second group of m-phase windings are wound so that a group of m-phase windings leaving the first layer enters the second layer, and a group of m-phase windings leaving the second layer enters the first layer, and the first group of m-phase windings and the second group of m-phase windings are alternately arranged in the slots in the radial direction (see, e.g., PTL 6).

In, e.g., a wave-wound winding for a three-phase rotating electrical machine having coil conductors wound in a full-pitch wave winding configuration, the coil conductors each having coil side portions alternately inserted into slots in a stator core, and a coil end portion that is formed integrally with the coil side portions and connects end portions of the coil side portions on an identical side to each other, a wave-wound winding for a three-phase rotating electrical machine is known in which the slots are provided as integer slots formed by an integer number of slots per pole per phase, and include a single-phase slot forming one slot that accommodates coil side portions of a single phase among three phases, and a plural-phase slot forming one slot that accommodates coil side portions of a plurality of phases among the three phases, the wave-wound winding is formed by connecting, in series with each other, a plurality of partial coils having a circumferential direction length equal to a stator circumferential multiple defined by a natural number multiple of a circumferential direction length of the stator core, and an equivalent configuration with an equal number of coil side portions, with the partial coils adjacent to each other in a radial direction of the stator core being arranged so that one partial coil of the adjacent partial coils is shifted from the other partial coil of the adjacent partial coils by a predetermined number of slots in a moving direction of a movable element magnetic pole, and the number of partial coils equal in number to the partial coils connected in series with each other is set to a natural number equal to or smaller than the number of slots per pole per phase, and an amount of shift corresponding to the predetermined number of slots between the adjacent partial coils is set to a natural number equal to or smaller than a natural number obtained by subtracting 1 from the number of slots per pole per phase (see, e.g., PTL 7).

In, e.g., a multiphase wave-wound winding for a rotating electrical machine including slot conducting portions that have coil conductors of respective phases formed by rectangular wires and wound by wave winding to be alternately inserted into slots extending in an axial direction of a cylindrical core, and are stacked on each other in the slots, and crossover conducting portions that connect the slot conducting portions to each other, and project from two end faces of the core in the axial direction to form coil ends, a multiphase wave-wound winding for a rotating electrical machine is known in which each of the crossover conducting portions is formed in a U shape by a pair of extension portions extending from the slot conducting portions in the axial direction, and a connection portion that connects ends of the pair of extension portions to each other, and the crossover conducting portions are sequentially stacked on each other upon being bent at different angles in a radial direction of the core with respect to the axial direction (see, e.g., PTL 8).

In, e.g., a method for manufacturing a stator for a rotating electrical machine on which a coil is wound, a method for manufacturing a stator for a rotating electrical machine is known that includes a step of periodically winding a coil in a plurality of grooves of a coil shaping jig including the grooves aligned in a longitudinal direction, and further winding the coil in the grooves by bending back the coil in the groove at an end of the coil in a winding direction, a step of transferring the coil wound on the coil shaping jig in a plurality of slots of an inner core, formed by a magnetic body and including the slots aligned in a circumferential direction to open on an outer circumferential side, so that two ends of the coil in the winding direction are located in an identical slot of the slots, and a step of fixing an outer core formed by a magnetic body to opening portions of the slots on the outer circumferential side (see, e.g., PTL 9).

A rotating electrical machine, for example, is known that includes a three-phase stator winding having a plurality of coils connected in parallel with each other in a wave winding configuration so that two or more parallel circuits are provided for each phase, and a stator core including a plurality of slots, each of which accommodates two or more coils of the coils forming the parallel circuits of an identical phase (see, e.g., PTL 10).

### CITATIONS LIST

### Patent Literature

[PTL 1] Japanese Unexamined Patent Publication (Kokai) No. 2016-152730

[PTL 2] Japanese Unexamined Patent Publication (Kokai) No. S59-222066

[PTL 3] Japanese Patent No. 4292877

[PTL 4] Japanese Unexamined Patent Publication (Kokai) No. 2002-034191

[PTL 5] Japanese Unexamined Patent Publication (Kokai) No. 2014-090614

[PTL 6] Japanese Unexamined Patent Publication (Kokai) No. 2012-152006

[PTL 7] Japanese Patent No. 6191450

[PTL 8] Japanese Unexamined Patent Publication (Kokai) No. 2010-142019

[PTL 9] Japanese Patent No. 4734159

[PTL 10] Japanese Unexamined Patent Publication (Kokai) No. 2018-157709

### SUMMARY OF INVENTION

### Technical Problem

In a three-phase AC motor in which the value obtained by dividing the number of slots by the number of poles takes an irreducible fraction, since the arrangement of windings by distributed winding is complicated, the number of coils of windings inserted into the slots is large, and the motor is therefore unsuitable for automation of a winding process in its manufacture. Wave winding is more suitable for automation of a winding process than lap winding and concentric winding, but in the former, for example, pluralities of annular coils and small coils may be preferably prepared and arranged in the slots, and a large number of coils are therefore used, posing a problem in terms of complication of a manufacturing method. It is, therefore, desired to achieve a coil structure of distributed winding that allows easy automatic winding in a three-phase AC motor in which the value obtained by dividing the number of slots by the number of poles takes an irreducible fraction.

### Solution To Problem

According to one aspect of the present disclosure, a stator for a fractional-slot three-phase alternating-current motor in which the number of slots 6N (N is a positive integer) of slots arranged in a circumferential direction is larger than 1.5 times the number of poles 2P (P is a positive integer), and a value obtained by dividing the number of slots 6N by the number of poles 2P takes an irreducible fraction comprises, letting X (X is a positive integer) be a quotient of the value obtained by dividing the number of slots 6N by the number of poles 2P, six groups of coils formed by coils arranged in the slots by wave winding at a slot pitch of one of X and X+1, wherein the six groups of coils are shifted in position from each other by 60 degrees in a circumferential direction.

According to another aspect of the present disclosure, a three-phase alternating-current motor comprises the above-mentioned stator, and a rotor facing the stator in a radial direction.

According to still another aspect of the present disclosure, a method for manufacturing a stator for a fractional-slot three-phase alternating-current motor in which the number of slots 6N (N is a positive integer) of slots arranged in a circumferential direction is larger than 1.5 times the number of poles 2P (P is a positive integer), and a value obtained by dividing the number of slots 6N by the number of poles 2P takes an irreducible fraction comprises a first insulation step of mounting a first insulator in the slots on an inner core in which the slots are formed to open on an outer circumferential side, a coil group formation step of forming a group of coils of wave winding by inserting a coil shaped into a wave winding shape into the slots, mounted with the first insulator, at a slot pitch of one of X and X+1 when a quotient of the value obtained by dividing the number of slots 6N by the number of poles 2P is defined as X (X is a positive integer), a second insulation step of mounting a second insulator in the slots on an outer circumferential side of the coil, and an outer core disposing step of disposing an outer core on an outer circumferential side of the inner core having the slots mounted with the first insulator, the group of coils, and the second insulator.

### Advantageous Effects of Invention

According to one aspect of the present disclosure, it is possible to achieve a stator having a coil structure of distributed winding that allows automatic winding by an easy process in a three-phase AC motor in which the value obtained by dividing the number of slots by the number of poles takes an irreducible fraction.

### BRIEF DESCRIPTION OF DRAWINGS

FIG. 1 is a developed sectional view illustrating the coil arrangement of a stator in a 10-pole, 36-slot three-phase AC motor according to an embodiment of the present disclosure.

FIG. 2 is an external view of the stator in the 10-pole, 36-slot three-phase AC motor according to the embodiment of the present disclosure.

FIG. 3A is a diagram illustrating the relationship between slot pitches and coil ends of the stator in the 10-pole, 36-slot three-phase AC motor according to the embodiment of the present disclosure, and depicts an external view of the stator.

FIG. 3B is a diagram illustrating the relationship between the slot pitches and the coil ends of the stator in the 10-pole, 36-slot three-phase AC motor according to the embodiment of the present disclosure, and depicts a sectional view of the stator.

FIG. 4A is a developed sectional view for explaining the arrangement of a first group of coils of the stator in the 10-pole, 36-slot three-phase AC motor according to the embodiment of the present disclosure.

FIG. 4B is a sectional view for explaining the arrangement of the first group of coils of the stator in the 10-pole, 36-slot three-phase AC motor according to the embodiment of the present disclosure.

FIG. 5 is a diagram illustrating a schematic circle for explaining the arrangement of the first group of coils of the stator illustrated in FIGS. 4A and 4B.

FIG. 6A is a developed sectional view for explaining the arrangement of a first group of coils of the stator in the 10-pole, 36-slot three-phase AC motor according to the embodiment of the present disclosure.

FIG. 6B is a sectional view for explaining the arrangement of the first group of coils of the stator in the 10-pole, 36-slot three-phase AC motor according to the embodiment of the present disclosure.

FIG. 7 is a diagram illustrating a schematic circle representing the positions of the start and the start of winding of groups of coils in the stator illustrated in FIGS. 1 to 6B.

FIG. 8 is a diagram illustrating schematic circles representing the coil arrangements of the groups of coils in the stator illustrated in FIGS. 1 to 6B.

FIG. 9 is a developed sectional view (part 1) for explaining the configuration of a three-phase winding formed by the groups of coils of the stator illustrated in FIGS. 1 to 8.

FIG. 10 is a developed sectional view (part 2) for explaining the configuration of a three-phase winding formed by the groups of coils of the stator illustrated in FIGS. 1 to 8.

FIG. 11 is a diagram illustrating a schematic circle representing groups of coils formed by windings disposed in a pattern drawn with a single line in the stator of the 10-pole, 36-slot three-phase AC motor according to the embodiment of the present disclosure.

FIG. 12 is a developed sectional view for explaining the groups of coils formed by the windings disposed in the pattern drawn with a single line in the stator of the 10-pole, 36-slot three-phase AC motor according to the embodiment of the present disclosure.

FIG. 13A is a sectional view for explaining the line symmetry of the winding arrangement of the stator in the 10-pole, 36-slot three-phase AC motor illustrated in FIGS. 1 to 12, and depicts −U-phase windings.

FIG. 13B is a sectional view for explaining the line symmetry of the winding arrangement of the stator in the 10-pole, 36-slot three-phase AC motor illustrated in FIGS. 1 to 12, and depicts +V-phase windings.

FIG. 13C is a sectional view for explaining the line symmetry of the winding arrangement of the stator in the 10-pole, 36-slot three-phase AC motor illustrated in FIGS. 1 to 12, and depicts −W-phase windings.

FIG. 13D is a sectional view for explaining the line symmetry of the winding arrangement of the stator in the 10-pole, 36-slot three-phase AC motor illustrated in FIGS. 1 to 12, and depicts +U-phase windings.

FIG. 13E is a sectional view for explaining the line symmetry of the winding arrangement of the stator in the 10-pole, 36-slot three-phase AC motor illustrated in FIGS. 1 to 12, and depicts −V-phase windings.

FIG. 13F is a sectional view for explaining the line symmetry of the winding arrangement of the stator in the 10-pole, 36-slot three-phase AC motor illustrated in FIGS. 1 to 12, and depicts +W-phase windings.

FIG. 14 is a developed sectional view illustrating the coil arrangement of a stator in a 10-pole, 24-slot three-phase AC motor according to an embodiment of the present disclosure.

FIG. 15 is a diagram illustrating schematic circles representing the coil arrangements of groups of coils in the stator illustrated in FIG. 14.

FIG. 16 is a diagram illustrating a schematic circle representing the positions of the start and the start of winding of the groups of coils in the stator illustrated in FIGS. 14 and 15.

FIG. 17 is a diagram illustrating a schematic circle representing groups of coils formed by windings disposed in a pattern drawn with a single line in the stator of the 10-pole, 24-slot three-phase AC motor according to the embodiment of the present disclosure.

FIG. 18 is a developed sectional view for explaining the groups of coils formed by the windings disposed in the pattern drawn with a single line in the stator of the 10-pole, 24-slot three-phase AC motor according to the embodiment of the present disclosure.

FIG. 19 is a developed sectional view illustrating the coil arrangement of a stator in an 8-pole, 30-slot three-phase AC motor according to an embodiment of the present disclosure.

FIG. 20A is a diagram illustrating a schematic circle representing the coil arrangement of groups of coils in the stator illustrated in FIG. 19, and depicts the arrangement of a first group of coils.

FIG. 20B is a diagram illustrating a schematic circle representing the coil arrangement of the groups of coils in the stator illustrated in FIG. 19, and depicts a schematic circle representing the positions of the start and the start of winding of the groups of coils in the stator.

FIG. 21 is a sectional view for explaining the rotational symmetry of the winding arrangement in the 8-pole, 30-slot three-phase AC motor according to the embodiment of the present disclosure.

FIG. 22 is a developed sectional view illustrating the coil arrangement of a stator in an 8-pole, 36-slot three-phase AC motor according to an embodiment of the present disclosure.

FIG. 23A is a diagram illustrating a schematic circle representing the coil arrangement of groups of coils in the stator illustrated in FIG. 22, and depicts the arrangement of a first group of coils.

FIG. 23B is a diagram illustrating a schematic circle representing the coil arrangement of the groups of coils in the stator illustrated in FIG. 22, and depicts a schematic circle representing the positions of the start and the start of winding of the groups of coils in the stator.

FIG. 24 is a sectional view for explaining the rotational symmetry of the winding arrangement in the 8-pole, 36-slot three-phase AC motor according to the embodiment of the present disclosure.

FIG. 25 is a table illustrating the relationship between the number of poles and the number of slots in a three-phase AC motor that can employ the slot arrangement according to any embodiment of the present disclosure.

FIG. 26A is a perspective view illustrating an inner core used in the stator of the three-phase AC motor according to any embodiment of the present disclosure.

FIG. 26B is a top view illustrating the inner core used in the stator of the three-phase AC motor according to the embodiment of the present disclosure.

FIG. 27A is a perspective view illustrating the state in which first insulators are mounted on the inner core illustrated in FIGS. 26A and 26B.

FIG. 27B is a top view illustrating the state in which the first insulators are mounted on the inner core illustrated in FIGS. 26A and 26B.

FIG. 28A is a perspective view illustrating a rectangular wire used in the stator of the three-phase AC motor according to any embodiment of the present disclosure, and depicts a wire implemented as a rectangular wire.

FIG. 28B is a perspective view illustrating the rectangular wire used in the stator of the three-phase AC motor according to the embodiment of the present disclosure, and depicts a winding wound by wave winding.

FIG. 29A is a perspective view for explaining processing of disposing the winding wound by wave winding illustrated in FIG. 28B on the inner core mounted with the first insulators illustrated in FIGS. 27A and 27B, and depicts the inner core during the processing of disposing the winding.

FIG. 29B is a perspective view for explaining the processing of disposing the winding wound by wave winding illustrated in FIG. 28B on the inner core mounted with the first insulators illustrated in FIGS. 27A and 27B, and depicts the inner core after such windings are disposed.

FIG. 30 is a perspective view illustrating the state in which second insulators are mounted on the inner core illustrated in FIGS. 29A and 29B.

FIG. 31 is a perspective view illustrating the state in which an outer core is disposed on the outer circumferential side of the inner core illustrated in FIG. 30.

FIG. 32 is a perspective view illustrating a stator obtained by cutting, at predetermined positions, windings arranged in the slots of the inner core illustrated in FIG. 31 in a pattern drawn with a single line, and connecting the windings to each other via crossover lines.

FIG. 33A is a diagram illustrating an exemplary conventional winding process in a stator including coils of wave winding of a three-phase AC motor.

FIG. 33B is a diagram illustrating the exemplary conventional winding process in the stator including the coils of wave winding of the three-phase AC motor.

FIG. 33C is a diagram illustrating the exemplary conventional winding process in the stator including the coils of wave winding of the three-phase AC motor.

FIG. 34 is a diagram illustrating an exemplary appearance of a three-phase AC motor including the stator according to any embodiment of the present disclosure.

FIG. 35 is a diagram for explaining the definition of a coil in one embodiment of the present disclosure.

FIG. 36A is a diagram for explaining the definition of a group of coils in one embodiment of the present disclosure, and depicts a schematic circle used to explain the coil arrangement.

FIG. 36B is a diagram for explaining the definition of the group of coils in the embodiment of the present disclosure, and depicts an appearance example of a cylindrical core.

### DESCRIPTION OF EMBODIMENTS

A stator having a coil structure of wave winding, and a three-phase AC motor including the stator will be described below with reference to the drawings. In the drawings, the same or similar reference numerals denote the same or similar members. To facilitate understanding, these drawings use different scales as appropriate. Further, the modes illustrated in the drawings are merely examples for carrying out the present invention, which is not limited to the modes illustrated in the drawings.

In the following description, wire implemented as a piece of wire such as copper wire that passes a current through it will be referred to as a “winding” hereinafter. A structure formed by wires shaped into a closed ring and stacked in a bundle as connected to each other in the same shape will be referred to as a “coil” hereinafter. Although the coil is divided into a portion accommodated in a slot of a stator and a portion that is not accommodated in the slot, the former will be referred to as a “winding” and the latter will be referred to as a “coil end” hereinafter, to clearly distinguish them from each other. The number of slots spanned by the coil accommodated in the slots of the stator will be referred to as a “slot pitch” hereinafter. Although the coil is divided into a portion accommodated in a slot of a stator and a portion that is not accommodated in the slot, the former will be referred to as a “winding” and the latter will be referred to as a “coil end” hereinafter, to clearly distinguish them from each other. A method for winding a coil around slots while alternately forming coil ends on the two end faces of the stator in the axial direction will be referred to as “wave winding” hereinafter.

2P (P is a positive integer) magnetic poles are set on a rotor facing a stator according to one embodiment of the present disclosure, and the value of 2P will be referred to as the number of poles hereinafter. P, that is, the value obtained by dividing the number of poles by 2 will be referred to as the number of pole pairs hereinafter.

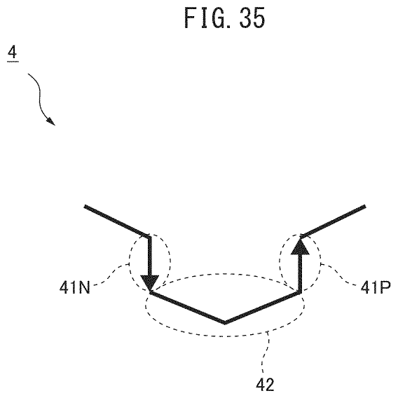

FIG. 35 is a diagram for explaining the definition of a coil in one embodiment of the present disclosure. A coil 4 is formed by a positive winding (+ winding) 41P and a negative winding (− winding) 41N accommodated in slots, and coil ends 42 that are not accommodated in the slots, as illustrated in FIG. 35. Since 180-degree out-of-phase currents respectively flow through the two windings (the positive winding and the negative winding) of the coil accommodated in the slots, a slot pitch corresponding to about 180 electrical degrees or a mechanical angle of about “(180 Degrees)/(Number of Poles)” is involved per pole. In an embodiment of the present disclosure, the slot pitch is defined by “Decimal Integer Part, That Is, Quotient of Value Obtained by (Number of Slots)/(Number of Poles)” or “(Decimal Integer Part, That Is, Quotient of Value Obtained by (Number of Slots)/(Number of Poles))+1.”

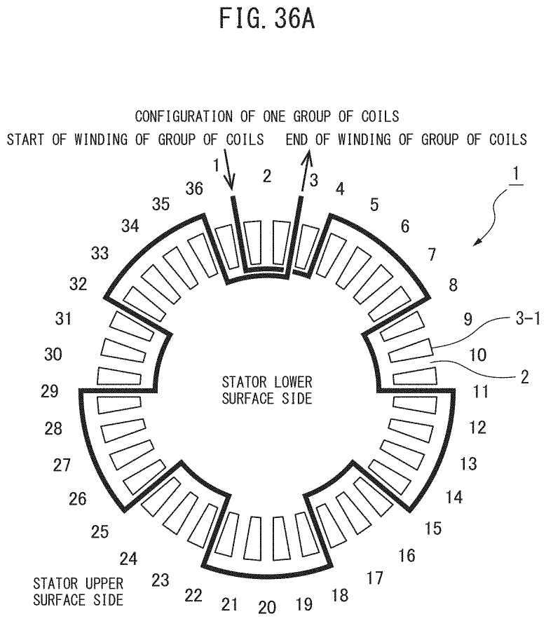

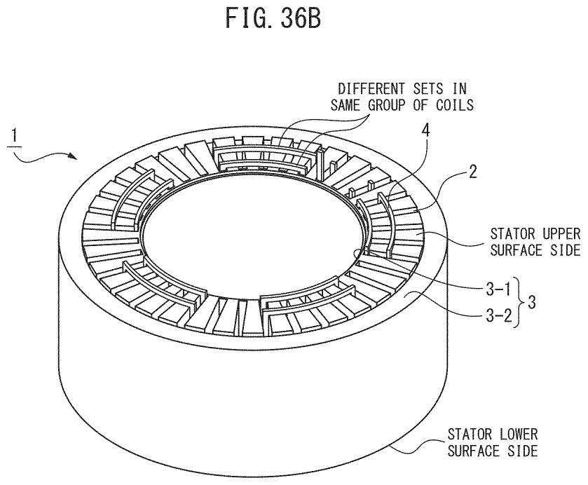

FIG. 36A is a diagram for explaining the definition of a group of coils in one embodiment of the present disclosure, and depicts a schematic circle used to explain the coil arrangement. FIG. 36B is a diagram for explaining the definition of the group of coils in the embodiment of the present disclosure, and depicts an appearance example of a cylindrical core.

In a stator 1, a core 3 includes an inner core 3-1, and an outer core 3-2 disposed on the outer circumferential side of the inner core 3-1, as illustrated in FIG. 36B. Slots 2 are formed in the inner core 3-1 to open on the outer circumferential side. The core 3 has a cylindrical shape, in which the side of one of the two bases of the core 3 will be referred to the “stator upper surface side,” and the side of the other base will be referred to as the “stator lower surface side” in the embodiment to be described hereinafter. In the embodiment of the present disclosure, in the stator 1, coil ends that are not accommodated in the slots 2 are exposed on the stator upper surface side and the stator lower surface side.

In the embodiment to be described hereinafter, the arrangement of the coil 4 in the inner core 3-1 is represented using a schematic circle as illustrated in FIG. 36A, for the sake of descriptive simplicity and clarity. In the schematic circle, the inner core 3-1 is represented by trapezoids arrayed in a circle. In the schematic circle as illustrated in FIG. 36A, the intervals between adjacent trapezoids correspond to the slots 2, but these intervals between the trapezoids do not represent the “opening directions” themselves of the slots 2 as illustrated in FIG. 36B. Each slot is assigned with a “slot identification number.” The stator lower surface side of the core 3 as illustrated in FIG. 36B corresponds to the inner circumferential side of the circular array of the trapezoids in the schematic circle as illustrated in FIG. 36A, and the stator upper surface side of the core 3 as illustrated in FIG. 36B corresponds to the outer circumferential side of the circular array of the trapezoids in the schematic circle as illustrated in FIG. 36A. In the schematic circle, further, the coil is indicated by a bold solid line, the start of winding of the coil in one group of coils is indicated by an arrow pointing from the outer circumferential side to the inner circumferential side of the schematic circle, and the end of winding of the coil in this group of coils is indicated by an arrow pointing from the inner circumferential side to the outer circumferential side of the schematic circle. FIG. 36A, for example, illustrates one group of coils in which the position of the start of winding of the coil is set in the slot represented by slot identification number 1, the coil is wound by wave winding with its coil ends being alternately exposed on the stator lower surface side and the stator upper surface side, and the position of the end of winding of the coil is set in the slot represented by slot identification number 3.

In the embodiment of the present disclosure, a collection of coils having the same positions of the start and the end of winding of a group of coils and the same slot arrangement will be referred to as a “group of coils” hereinafter. A collection of coils from the start of winding to the end of winding formed by a series of coils wound by wave winding will be referred to as a “set” hereinafter. Therefore, even in the same group of coils (i.e., a collection of coils having the same positions of the start and the end of winding of a group of coils and the same slot arrangement), when a plurality of collections of coils that are not formed by a series of coils are present, the respective collections are handled as separate “sets.” FIG. 36B, for example, illustrates two collections of coils having the same positions of the start and the end of winding of a group of coils and the same slot arrangement, and these two collections are handled as one “group of coils,” but when these two collections of coils are not formed by a series of coils, the respective collections of coils are handled as separate “sets.” In other words, separate sets of coils may be present in one group of coils. One set of coils may even be present alone in one group of coils, as a matter of course.

A stator according to an embodiment of the present disclosure, and a three-phase AC motor including the stator will be described below by taking the common example described with reference to FIGS. 35, 36A, and 36B.

A three-phase AC motor according to an embodiment of the present disclosure is provided as a fractional-slot three-phase AC motor in which the number of slots 6N (N is a positive integer) of slots arranged in the circumferential direction is larger than 1.5 times the number of poles 2P (P is a positive integer), and the value obtained by dividing the number of slots 6N by the number of poles 2P takes an irreducible fraction, and the motor includes a stator, and a rotor facing the stator in the radial direction. The value obtained by dividing the number of slots 6N by the number of poles 2P represents the slot pitch of a coil 4. In the three-phase AC motor in which the value obtained by dividing the number of slots 6N by the number of poles 2P is larger than 1.5, the slot pitch of the coil is 2 or more, thus forming a coil structure of distributed winding (lap winding). Letting X (X is a positive integer) be the quotient, that is, the decimal integer part of the value obtained by dividing the number of slots 6N by the number of poles 2P, the stator according to any embodiment of the present disclosure includes six groups of coils formed by coils arranged in the slots by wave winding at a slot pitch of X or X+1. The six groups of coils are shifted in position from each other by 60 degrees in the circumferential direction.

In, e.g., the 10-pole, 36-slot three-phase AC motor, since the value obtained by dividing the number of slots of 36 by the number of poles of 10 is 3.6, the motor satisfies the requirement “the number of slots is larger than 1.5 times the number of poles.” In addition, since 18/5 taken as the value obtained by dividing the number of slots of 36 by the number of poles of 10 is an irreducible fraction, the motor can be said to be of the fractional slot type.

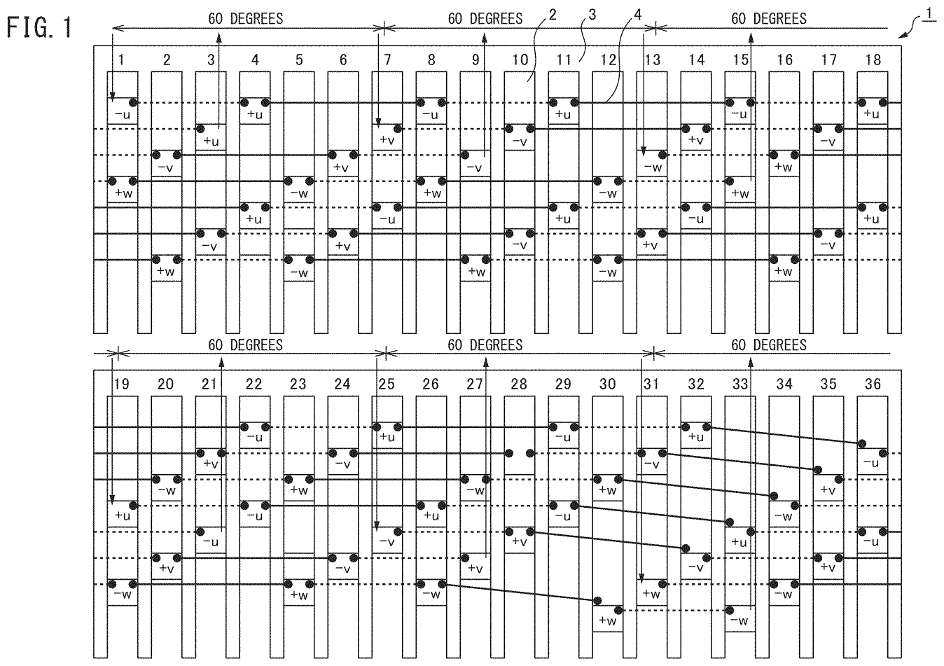

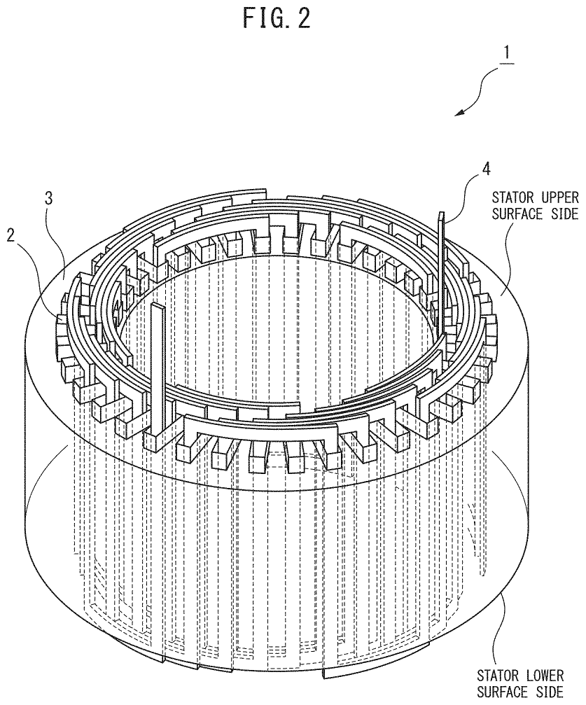

FIG. 1 is a developed sectional view illustrating the coil arrangement of a stator in a 10-pole, 36-slot three-phase AC motor according to an embodiment of the present disclosure. The stator 1 has a cylindrical shape in practice, but a developed sectional view depicting the cylindrical stator 1 as developed linearly will also be referred to in the following description, to facilitate understanding. Referring to FIG. 1, a coil arrangement corresponding to the 36 slots is illustrated in two rows (i.e., slot identification numbers 1 to 18 and slot identification numbers 19 to 36), for the sake of drawing simplicity and clarity. FIG. 2 is an external view of the stator in the 10-pole, 36-slot three-phase AC motor according to the embodiment of the present disclosure. FIG. 2 illustrates the coils 4 in the core 3 in a see-through view.

In FIG. 1 and the subsequent drawings, U, V, and W represent the respective phases of a three-phase alternating current and are out of phase with each other by ±120 electrical degrees. “+” and “−” represent the directions of currents and are out of phase with each other by 180 electrical degrees. Two of a total of six phase belts: +U, −U, +V, −V, +W, and −W are disposed in each slot 2 formed in the core 3 of the stator 1. The same number of wires such as copper wires that pass currents through them are inserted in each arrangement. In the subsequent developed sectional views, coil ends exposed on the stator upper surface side (i.e., coils that are not accommodated in the slots 2) are indicated by solid lines, and coil ends exposed on the stator lower surface side are indicated by broken lines. Windings accommodated in the slots 2 (i.e., windings extending from the stator upper surface side to the stator lower surface side or from the stator lower surface side to the stator upper surface side in the same slots) are indicated by black circles “•” In the subsequent developed sectional views as well, the start of winding of the coil in one group of coils is indicated by a down arrow, and the end of winding of the coil in this group of coils is indicated by an up arrow.

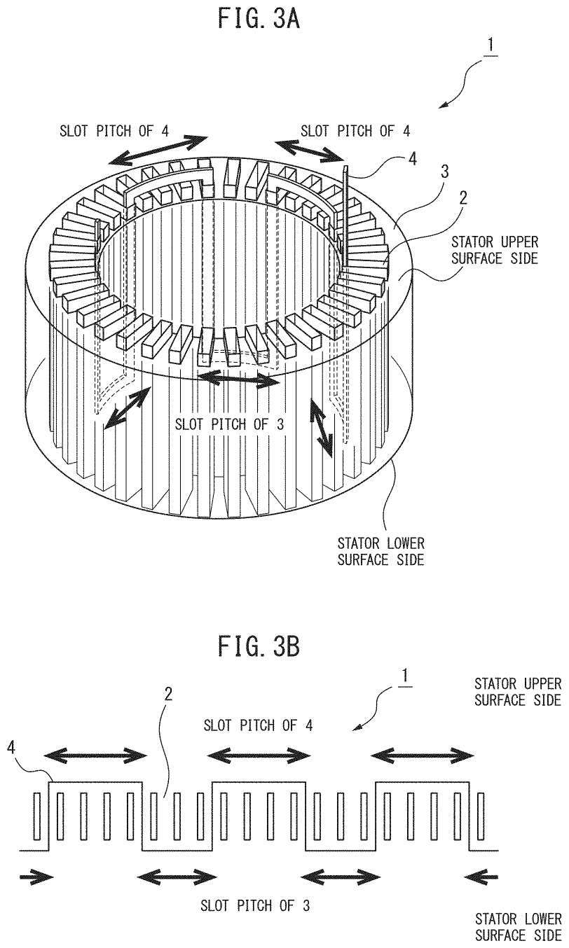

FIG. 3A is a diagram illustrating the relationship between slot pitches and coil ends of the stator in the 10-pole, 36-slot three-phase AC motor according to the embodiment of the present disclosure, and depicts an external view of the stator. FIG. 3B is a diagram illustrating the relationship between the slot pitches and the coil ends of the stator in the 10-pole, 36-slot three-phase AC motor according to the embodiment of the present disclosure, and depicts a sectional view of the stator. FIG. 3A illustrates the coils 4 in the core 3 in a see-through view.

In the 10-pole, 36-slot three-phase AC motor, since the quotient, that is, the decimal integer part of the value obtained by dividing the number of slots of 36 by the number of poles of 10 is 3, the stator 1 is provided with six groups of coils formed by the coils 4 arranged in the slots 2 by wave winding at a slot pitch of 3 or 4(=3+1). The six groups of coils are shifted in position from each other by 60 degrees in the circumferential direction.

Especially the 10-pole, 36-slot three-phase AC motor can be provided with groups of coils formed by coils of wave winding arranged in the slots 2 to alternately repeat a slot pitch of 3 and a slot pitch of 4. For example, coil ends corresponding to a slot pitch of 4 are exposed on the stator upper surface side, and coil ends corresponding to a slot pitch of 3 are exposed on the stator lower surface side, as illustrated in FIGS. 3A and 3B. Further, 7 taken as the value obtained by summing the respective numbers of slot pitches, that is, the slot pitch of 3 and the slot pitch of 4 corresponds to a slot pitch for approximately every two poles (one pole pair). The value obtained by multiplying this value of 7 by the number of pole pairs of 5 (the value obtained by dividing the number of poles of 10 by 2) is 35, which does not match the total number of slots of 36, and, therefore, even when wave winding is performed around the slots of the stator alternately at a slot pitch of 3 and a slot pitch of 4 to span 360 degrees in the circumferential direction of the stator, no return to the original position (the position of the start of winding) is made. This feature is obtained because 7 taken as the value obtained by summing the respective numbers of slot pitches, that is, the slot pitch of 3 and the slot pitch of 4, and the number of slots of 36 are relatively prime.

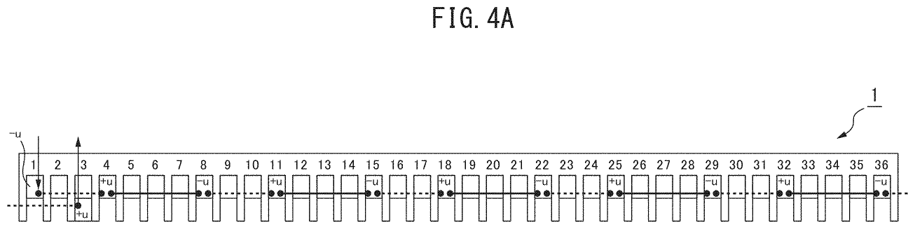

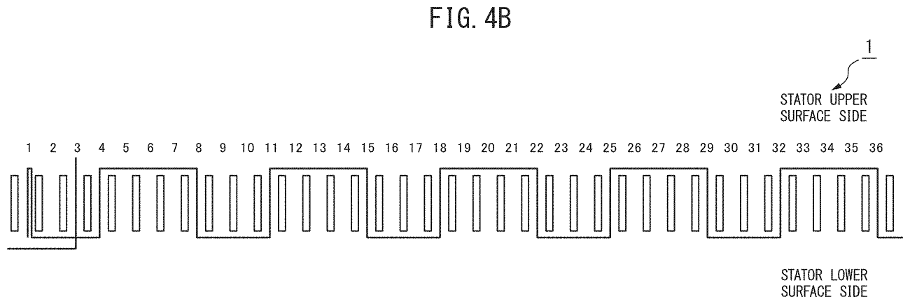

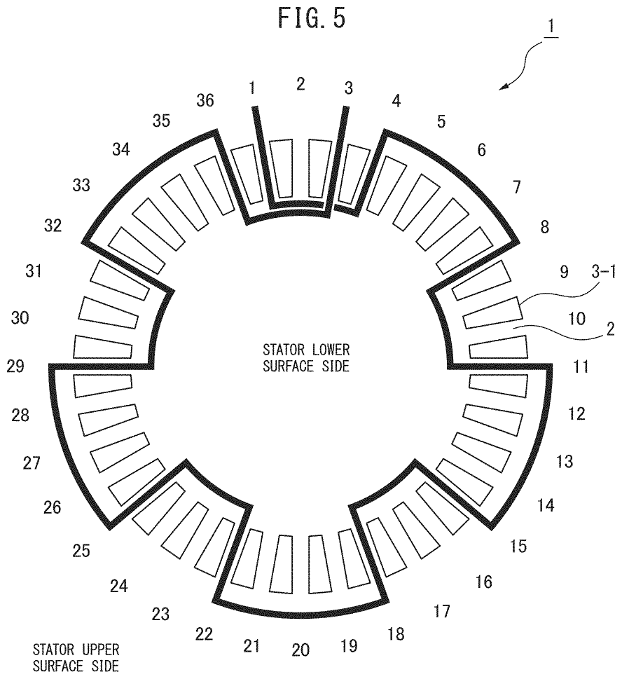

FIG. 4A is a developed sectional view for explaining the arrangement of a first group of coils of the stator in the 10-pole, 36-slot three-phase AC motor according to the embodiment of the present disclosure. FIG. 4B is a sectional view for explaining the arrangement of the first group of coils of the stator in the 10-pole, 36-slot three-phase AC motor according to the embodiment of the present disclosure. FIG. 5 is a diagram illustrating a schematic circle for explaining the arrangement of the first group of coils of the stator illustrated in FIGS. 4A and 4B.

As illustrated in FIGS. 1, 4A, 4B, and 5, in the first group of coils, the coil is inserted from the stator upper surface side to the stator lower surface side of the slot having slot identification number 1, and inserted from the stator lower surface side to the stator upper surface side of the slot having slot identification number 4 shifted from that having slot identification number 1 by a slot pitch of 3. The coil is further inserted from the stator upper surface side to the stator lower surface side of the slot having slot identification number 8 shifted from that having slot identification number 4 by a slot pitch of 4, and inserted from the stator lower surface side to the stator upper surface side of the slot having slot identification number 11 shifted from that having slot identification number 8 by a slot pitch of 3. The coil is further inserted from the stator upper surface side to the stator lower surface side of the slot having slot identification number 15 shifted from that having slot identification number 11 by a slot pitch of 4, and inserted from the stator lower surface side to the stator upper surface side of the slot having slot identification number 18 shifted from that having slot identification number 15 by a slot pitch of 3. The coil is further inserted from the stator upper surface side to the stator lower surface side of the slot having slot identification number 22 shifted from that having slot identification number 18 by a slot pitch of 4, and inserted from the stator lower surface side to the stator upper surface side of the slot having slot identification number 25 shifted from that having slot identification number 22 by a slot pitch of 3. The coil is further inserted from the stator upper surface side to the stator lower surface side of the slot having slot identification number 29 shifted from that having slot identification number 25 by a slot pitch of 4, and inserted from the stator lower surface side to the stator upper surface side of the slot having slot identification number 32 shifted from that having slot identification number 29 by a slot pitch of 3. The coil is further inserted from the stator upper surface side to the stator lower surface side of the slot having slot identification number 36 shifted from that having slot identification number 32 by a slot pitch of 4, and inserted from the stator lower surface side to the stator upper surface side of the slot having slot identification number 3 shifted from that having slot identification number 36 by a slot pitch of 3. In this manner, in the first group of coils, the slot having slot identification number 1 is set as the position of the start of winding, and the slot having slot identification number 3 shifted from the slot having slot identification number 1 by 360 degrees clockwise plus an amount of two slots (20 degrees) clockwise is set as the position of the end of winding. The thus disposed first group of coils forms a half of first-phase windings (e.g., U-phase windings).

The second to sixth groups of coils are similarly formed by coils of wave winding arranged in the slots 2 to alternately repeat a slot pitch of 3 and a slot pitch of 4.

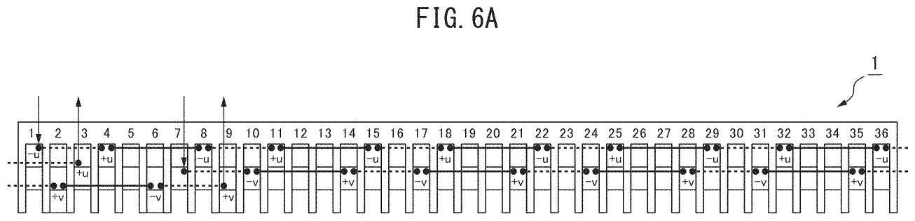

FIG. 6A is a developed sectional view for explaining the arrangement of a first group of coils of the stator in the 10-pole, 36-slot three-phase AC motor according to the embodiment of the present disclosure. FIG. 6B is a sectional view for explaining the arrangement of the first group of coils of the stator in the 10-pole, 36-slot three-phase AC motor according to the embodiment of the present disclosure.

As illustrated in FIGS. 1, 6A, and 6B, the second group of coils is shifted in position from the first group of coils by 60 degrees in the circumferential direction (in the example illustrated in FIGS. 1, 6A, and 6B, clockwise). In other words, the slot having slot identification number 7 shifted from the slot having slot identification number 1, that is, from the position of the start of winding of the first group of coils by a slot pitch of 6 (60 degrees) is set as the position of the start of winding of the second group of coils. More specifically, in the second group of coils, the coil is inserted from the stator upper surface side to the stator lower surface side of the slot having slot identification number 7, and inserted from the stator lower surface side to the stator upper surface side of the slot having slot identification number 10 shifted from that having slot identification number 7 by a slot pitch of 3. The coil is further inserted from the stator upper surface side to the stator lower surface side of the slot having slot identification number 14 shifted from that having slot identification number 10 by a slot pitch of 4, and inserted from the stator lower surface side to the stator upper surface side of the slot having slot identification number 17 shifted from that having slot identification number 14 by a slot pitch of 3. The coil is further inserted from the stator upper surface side to the stator lower surface side of the slot having slot identification number 21 shifted from that having slot identification number 17 by a slot pitch of 4, and inserted from the stator lower surface side to the stator upper surface side of the slot having slot identification number 24 shifted from that having slot identification number 21 by a slot pitch of 3. The coil is further inserted from the stator upper surface side to the stator lower surface side of the slot having slot identification number 28 shifted from that having slot identification number 24 by a slot pitch of 4, and inserted from the stator lower surface side to the stator upper surface side of the slot having slot identification number 31 shifted from that having slot identification number 28 by a slot pitch of 3. The coil is further inserted from the stator upper surface side to the stator lower surface side of the slot having slot identification number 35 shifted from that having slot identification number 31 by a slot pitch of 4, and inserted from the stator lower surface side to the stator upper surface side of the slot having slot identification number 38 shifted from that having slot identification number 35 by a slot pitch of 3. The coil is further inserted from the stator upper surface side to the stator lower surface side of the slot having slot identification number 6 shifted from that having slot identification number 2 by a slot pitch of 4, and inserted from the stator lower surface side to the stator upper surface side of the slot having slot identification number 9 shifted from that having slot identification number 6 by a slot pitch of 3. In this manner, in the second group of coils, the slot having slot identification number 7 is set as the position of the start of winding, and the slot having slot identification number 9 shifted from the slot having slot identification number 7 by 360 degrees clockwise plus an amount of two slots (20 degrees) clockwise is set as the position of the end of winding. The thus disposed second group of coils forms a half of second-phase windings (e.g., V-phase windings).

The third group of coils is shifted in position from the second group of coils by 60 degrees in the circumferential direction (in the example illustrated in FIG. 1, clockwise), and the fourth group of coils is shifted in position from the third group of coils by 60 degrees in the circumferential direction (in the example illustrated in FIG. 1, clockwise). The fifth group of coils is shifted in position from the fourth group of coils by 60 degrees in the circumferential direction (in the example illustrated in FIG. 1, clockwise), and the sixth group of coils is shifted in position from the fifth group of coils by 60 degrees in the circumferential direction (in the example illustrated in FIG. 1, clockwise).

In other words, as illustrated in FIG. 1, the third group of coils is shifted in position from the second group of coils by 60 degrees in the circumferential direction (in the example illustrated in FIG. 1, clockwise). In other words, the slot having slot identification number 13 shifted from the slot having slot identification number 7, that is, from the position of the start of winding of the second group of coils by a slot pitch of 6 is set as the position of the start of winding of the third group of coils. More specifically, in the third group of coils, the coil is inserted from the stator upper surface side to the stator lower surface side of the slot having slot identification number 13, and inserted from the stator lower surface side to the stator upper surface side of the slot having slot identification number 16 shifted from that having slot identification number 13 by a slot pitch of 3. The coil is further inserted from the stator upper surface side to the stator lower surface side of the slot having slot identification number 20 shifted from that having slot identification number 16 by a slot pitch of 4, and inserted from the stator lower surface side to the stator upper surface side of the slot having slot identification number 23 shifted from that having slot identification number 20 by a slot pitch of 3. The coil is further inserted from the stator upper surface side to the stator lower surface side of the slot having slot identification number 27 shifted from that having slot identification number 23 by a slot pitch of 4, and inserted from the stator lower surface side to the stator upper surface side of the slot having slot identification number 30 shifted from that having slot identification number 27 by a slot pitch of 3. The coil is further inserted from the stator upper surface side to the stator lower surface side of the slot having slot identification number 34 shifted from that having slot identification number 30 by a slot pitch of 4, and inserted from the stator lower surface side to the stator upper surface side of the slot having slot identification number 1 shifted from that having slot identification number 34 by a slot pitch of 3. The coil is further inserted from the stator upper surface side to the stator lower surface side of the slot having slot identification number 5 shifted from that having slot identification number 1 by a slot pitch of 4, and inserted from the stator lower surface side to the stator upper surface side of the slot having slot identification number 8 shifted from that having slot identification number 5 by a slot pitch of 3. The coil is further inserted from the stator upper surface side to the stator lower surface side of the slot having slot identification number 12 shifted from that having slot identification number 8 by a slot pitch of 4, and inserted from the stator lower surface side to the stator upper surface side of the slot having slot identification number 15 shifted from that having slot identification number 12 by a slot pitch of 3. In this manner, in the third group of coils, the slot having slot identification number 13 is set as the position of the start of winding, and the slot having slot identification number 15 shifted from the slot having slot identification number 13 by 360 degrees clockwise plus an amount of two slots (20 degrees) clockwise is set as the position of the end of winding. The thus disposed third group of coils can be used as a half of third-phase windings (e.g., W-phase windings).

As illustrated in FIG. 1, the fourth group of coils is shifted in position from the third group of coils by 60 degrees in the circumferential direction (in the example illustrated in FIG. 1, clockwise). In other words, the slot having slot identification number 19 shifted from the slot having slot identification number 13, that is, from the position of the start of winding of the third group of coils by a slot pitch of 6 is set as the position of the start of winding of the fourth group of coils. More specifically, in the fourth group of coils, the coil is inserted from the stator upper surface side to the stator lower surface side of the slot having slot identification number 19, and inserted from the stator lower surface side to the stator upper surface side of the slot having slot identification number 22 shifted from that having slot identification number 19 by a slot pitch of 3. The coil is further inserted from the stator upper surface side to the stator lower surface side of the slot having slot identification number 26 shifted from that having slot identification number 22 by a slot pitch of 4, and inserted from the stator lower surface side to the stator upper surface side of the slot having slot identification number 29 shifted from that having slot identification number 26 by a slot pitch of 3. The coil is further inserted from the stator upper surface side to the stator lower surface side of the slot having slot identification number 33 shifted from that having slot identification number 29 by a slot pitch of 4, and inserted from the stator lower surface side to the stator upper surface side of the slot having slot identification number 36 shifted from that having slot identification number 33 by a slot pitch of 3. The coil is further inserted from the stator upper surface side to the stator lower surface side of the slot having slot identification number 4 shifted from that having slot identification number 36 by a slot pitch of 4, and inserted from the stator lower surface side to the stator upper surface side of the slot having slot identification number 7 shifted from that having slot identification number 4 by a slot pitch of 3. The coil is further inserted from the stator upper surface side to the stator lower surface side of the slot having slot identification number 11 shifted from that having slot identification number 7 by a slot pitch of 4, and inserted from the stator lower surface side to the stator upper surface side of the slot having slot identification number 14 shifted from that having slot identification number 11 by a slot pitch of 3. The coil is further inserted from the stator upper surface side to the stator lower surface side of the slot having slot identification number 18 shifted from that having slot identification number 14 by a slot pitch of 4, and inserted from the stator lower surface side to the stator upper surface side of the slot having slot identification number 21 shifted from that having slot identification number 18 by a slot pitch of 3. In this manner, in the fourth group of coils, the slot having slot identification number 19 is set as the position of the start of winding, and the slot having slot identification number 21 shifted from the slot having slot identification number 19 by 360 degrees clockwise plus an amount of two slots (20 degrees) clockwise is set as the position of the end of winding. The thus disposed fourth group of coils can be used as the remaining half of the first-phase windings (e.g., U-phase windings).

As illustrated in FIG. 1, the fifth group of coils is shifted in position from the fourth group of coils by 60 degrees in the circumferential direction (in the example illustrated in FIG. 1, clockwise). In other words, the slot having slot identification number 25 shifted from the slot having slot identification number 19, that is, from the position of the start of winding of the fourth group of coils by a slot pitch of 6 is set as the position of the start of winding of the fifth group of coils. More specifically, in the fifth group of coils, the coil is inserted from the stator upper surface side to the stator lower surface side of the slot having slot identification number 25, and inserted from the stator lower surface side to the stator upper surface side of the slot having slot identification number 28 shifted from that having slot identification number 25 by a slot pitch of 3. The coil is further inserted from the stator upper surface side to the stator lower surface side of the slot having slot identification number 32 shifted from that having slot identification number 28 by a slot pitch of 4, and inserted from the stator lower surface side to the stator upper surface side of the slot having slot identification number 35 shifted from that having slot identification number 32 by a slot pitch of 3. The coil is further inserted from the stator upper surface side to the stator lower surface side of the slot having slot identification number 3 shifted from that having slot identification number 35 by a slot pitch of 4, and inserted from the stator lower surface side to the stator upper surface side of the slot having slot identification number 6 shifted from that having slot identification number 3 by a slot pitch of 3. The coil is further inserted from the stator upper surface side to the stator lower surface side of the slot having slot identification number 10 shifted from that having slot identification number 6 by a slot pitch of 4, and inserted from the stator lower surface side to the stator upper surface side of the slot having slot identification number 13 shifted from that having slot identification number 10 by a slot pitch of 3. The coil is further inserted from the stator upper surface side to the stator lower surface side of the slot having slot identification number 17 shifted from that having slot identification number 13 by a slot pitch of 4, and inserted from the stator lower surface side to the stator upper surface side of the slot having slot identification number 20 shifted from that having slot identification number 17 by a slot pitch of 3. The coil is further inserted from the stator upper surface side to the stator lower surface side of the slot having slot identification number 24 shifted from that having slot identification number 20 by a slot pitch of 4, and inserted from the stator lower surface side to the stator upper surface side of the slot having slot identification number 27 shifted from that having slot identification number 24 by a slot pitch of 3. In this manner, in the fifth group of coils, the slot having slot identification number 25 is set as the position of the start of winding, and the slot having slot identification number 27 shifted from the slot having slot identification number 25 by 360 degrees clockwise plus an amount of two slots (20 degrees) clockwise is set as the position of the end of winding. The thus disposed fifth group of coils can be used as the remaining half of the second-phase windings (e.g., V-phase windings).

As illustrated in FIG. 1, the sixth group of coils is shifted in position from the fifth group of coils by 60 degrees in the circumferential direction (in the example illustrated in FIG. 1, clockwise). In other words, the slot having slot identification number 31 shifted from the slot having slot identification number 25, that is, from the position of the start of winding of the fifth group of coils by a slot pitch of 6 is set as the position of the start of winding of the sixth group of coils. More specifically, in the sixth group of coils, the coil is inserted from the stator upper surface side to the stator lower surface side of the slot having slot identification number 31, and inserted from the stator lower surface side to the stator upper surface side of the slot having slot identification number 34 shifted from that having slot identification number 31 by a slot pitch of 3. The coil is further inserted from the stator upper surface side to the stator lower surface side of the slot having slot identification number 2 shifted from that having slot identification number 34 by a slot pitch of 4, and inserted from the stator lower surface side to the stator upper surface side of the slot having slot identification number 5 shifted from that having slot identification number 2 by a slot pitch of 3. The coil is further inserted from the stator upper surface side to the stator lower surface side of the slot having slot identification number 9 shifted from that having slot identification number 5 by a slot pitch of 4, and inserted from the stator lower surface side to the stator upper surface side of the slot having slot identification number 12 shifted from that having slot identification number 9 by a slot pitch of 3. The coil is further inserted from the stator upper surface side to the stator lower surface side of the slot having slot identification number 16 shifted from that having slot identification number 12 by a slot pitch of 4, and inserted from the stator lower surface side to the stator upper surface side of the slot having slot identification number 19 shifted from that having slot identification number 16 by a slot pitch of 3. The coil is further inserted from the stator upper surface side to the stator lower surface side of the slot having slot identification number 23 shifted from that having slot identification number 19 by a slot pitch of 4, and inserted from the stator lower surface side to the stator upper surface side of the slot having slot identification number 26 shifted from that having slot identification number 23 by a slot pitch of 3. The coil is further inserted from the stator upper surface side to the stator lower surface side of the slot having slot identification number 30 shifted from that having slot identification number 26 by a slot pitch of 4, and inserted from the stator lower surface side to the stator upper surface side of the slot having slot identification number 33 shifted from that having slot identification number 30 by a slot pitch of 3. In this manner, in the sixth group of coils, the slot having slot identification number 31 is set as the position of the start of winding, and the slot having slot identification number 33 shifted from the slot having slot identification number 31 by 360 degrees clockwise plus an amount of two slots (20 degrees) clockwise is set as the position of the end of winding. The thus disposed sixth group of coils can be used as the remaining half of the third-phase windings (e.g., W-phase windings).

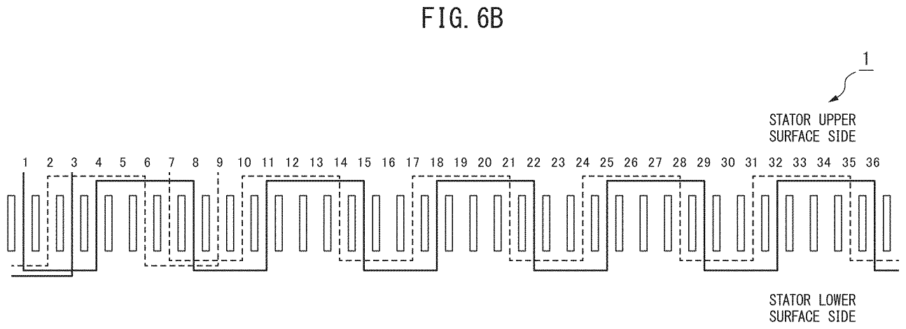

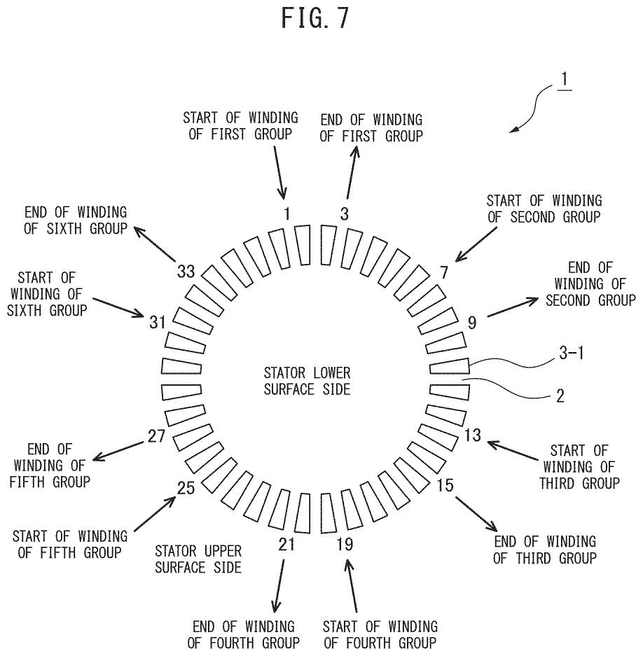

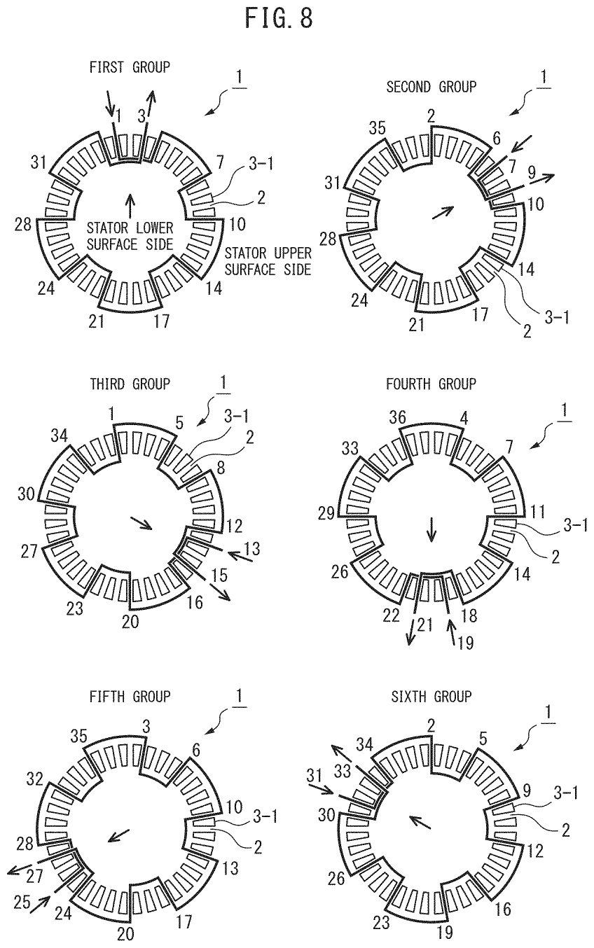

FIG. 7 is a diagram illustrating a schematic circle representing the positions of the start and the start of winding of groups of coils in the stator illustrated in FIGS. 1 to 6B. FIG. 8 is a diagram illustrating schematic circles representing the coil arrangements of the groups of coils in the stator illustrated in FIGS. 1 to 6B.

In the stator 1 of the 10-pole, 36-slot three-phase AC motor illustrated in FIGS. 1 to 6B, in the first group of coils, the slot having slot identification number 1 is set as the position of the start of winding, and the slot having slot identification number 3 shifted from the slot having slot identification number 1 by 360 degrees clockwise plus an amount of two slots (20 degrees) clockwise is set as the position of the end of winding. In the second group of coils, the slot having slot identification number 7 is set as the position of the start of winding, and the slot having slot identification number 9 shifted from the slot having slot identification number 7 by 360 degrees clockwise plus an amount of two slots (20 degrees) clockwise is set as the position of the end of winding. In the third group of coils, the slot having slot identification number 13 is set as the position of the start of winding, and the slot having slot identification number 15 shifted from the slot having slot identification number 13 by 360 degrees clockwise plus an amount of two slots (20 degrees) clockwise is set as the position of the end of winding. In the fourth group of coils, the slot having slot identification number 19 is set as the position of the start of winding, and the slot having slot identification number 21 shifted from the slot having slot identification number 19 by 360 degrees clockwise plus an amount of two slots (20 degrees) clockwise is set as the position of the end of winding. In the fifth group of coils, the slot having slot identification number 25 is set as the position of the start of winding, and the slot having slot identification number 27 shifted from the slot having slot identification number 25 by 360 degrees clockwise plus an amount of two slots (20 degrees) clockwise is set as the position of the end of winding. In the sixth group of coils, the slot having slot identification number 31 is set as the position of the start of winding, and the slot having slot identification number 33 shifted from the slot having slot identification number 31 by 360 degrees clockwise plus an amount of two slots (20 degrees) clockwise is set as the position of the end of winding.

For example, the first group of coils forms a half of first-phase windings (e.g., U-phase windings), and the fourth group of coils forms the remaining half of the first-phase windings (e.g., U-phase windings). First-phase windings (e.g., U-phase windings) in the stator 1 can be formed by connecting the first group of coils and the fourth group of coils to each other via a crossover line. The second group of coils forms a half of second-phase windings (e.g., V-phase windings), and the fifth group of coils forms the remaining half of the second-phase windings (e.g., V-phase windings). Second-phase windings (e.g., V-phase windings) in the stator 1 can be formed by connecting the second group of coils and the fifth group of coils to each other via a crossover line. The third group of coils forms a half of third-phase windings (e.g., W-phase windings), and the sixth group of coils forms the remaining half of the third-phase windings (e.g., W-phase windings). Third-phase windings (e.g., W-phase windings) in the stator 1 can be formed by connecting the third group of coils and the sixth group of coils to each other via a crossover line. In this manner, a three-phase winding can be formed by individually disposing the first to sixth groups of coils in the slots, and connecting the individual groups of coils to each other via crossover lines in the above-mentioned way.

The first to sixth groups of coils may be provided as a plurality of first groups of coils to a plurality of sixth groups of coils, respectively, to form a three-phase winding. Two examples of this configuration will be enumerated below.

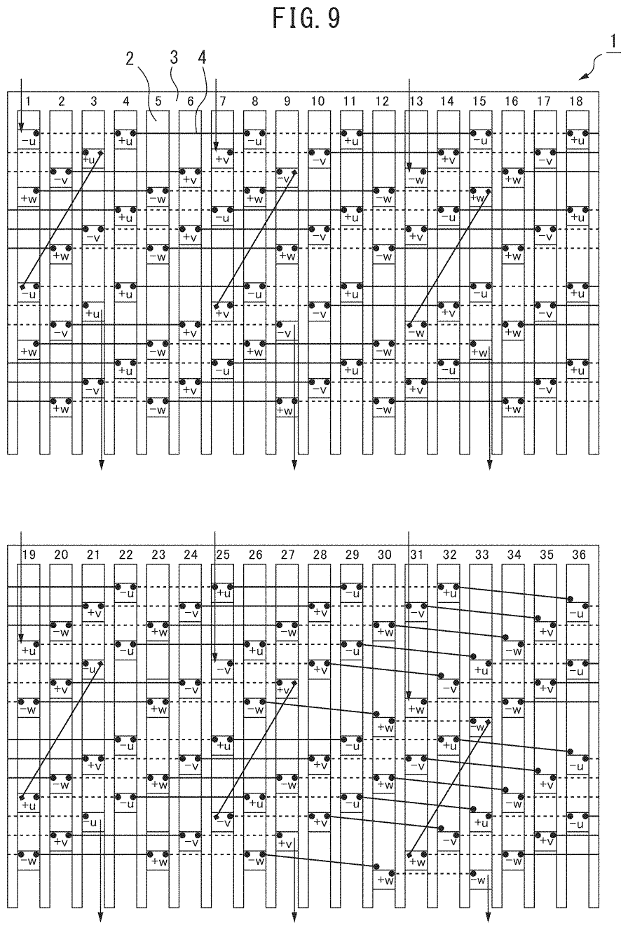

FIG. 9 is a developed sectional view (part 1) for explaining the configuration of a three-phase winding formed by the groups of coils of the stator illustrated in FIGS. 1 to 8. Referring to FIG. 9, a coil arrangement corresponding to the 36 slots is illustrated in two rows (i.e., slot identification numbers 1 to 18 and slot identification numbers 19 to 36), for the sake of drawing simplicity and clarity. When each group of coils of the stator 1 in the 10-pole, 36-slot three-phase AC motor illustrated in FIGS. 1 to 8 is disposed as two groups of coils to span 360 degrees each, the first to sixth groups of coils are provided as two first groups of coils to two sixth groups of coils, respectively. For example, for the two first groups of coils, coils with the slot having slot identification number 1 as the position of the start of winding are connected to each other via a crossover line, and coils with the slot having slot identification number 3 as the position of the end of winding are connected to each other via a crossover line. For the two second groups of coils, coils with the slot having slot identification number 7 as the position of the start of winding are connected to each other via a crossover line, and coils with the slot having slot identification number 9 as the position of the end of winding are connected to each other via a crossover line. For the two third groups of coils, coils with the slot having slot identification number 13 as the position of the start of winding are connected to each other via a crossover line, and coils with the slot having slot identification number 15 as the position of the end of winding are connected to each other via a crossover line. For the two fourth groups of coils, coils with the slot having slot identification number 19 as the position of the start of winding are connected to each other via a crossover line, and coils with the slot having slot identification number 21 as the position of the end of winding are connected to each other via a crossover line. For the two fifth groups of coils, coils with the slot having slot identification number 25 as the position of the start of winding are connected to each other via a crossover line, and coils with the slot having slot identification number 27 as the position of the end of winding are connected to each other via a crossover line. For the two sixth groups of coils, coils with the slot having slot identification number 31 as the position of the start of winding are connected to each other via a crossover line, and coils with the slot having slot identification number 33 as the position of the end of winding are connected to each other via a crossover line. First-phase windings (e.g., U-phase windings) in the stator 1 can be formed by connecting the above-mentioned two first groups of coils and two fourth groups of coils to each other via a crossover line. Second-phase windings (e.g., V-phase windings) in the stator 1 can be formed by connecting the above-mentioned two second groups of coils and two fifth groups of coils to each other via a crossover line. Third-phase windings (e.g., W-phase windings) in the stator 1 can be formed by connecting the above-mentioned two third groups of coils and two sixth groups of coils to each other via a crossover line.

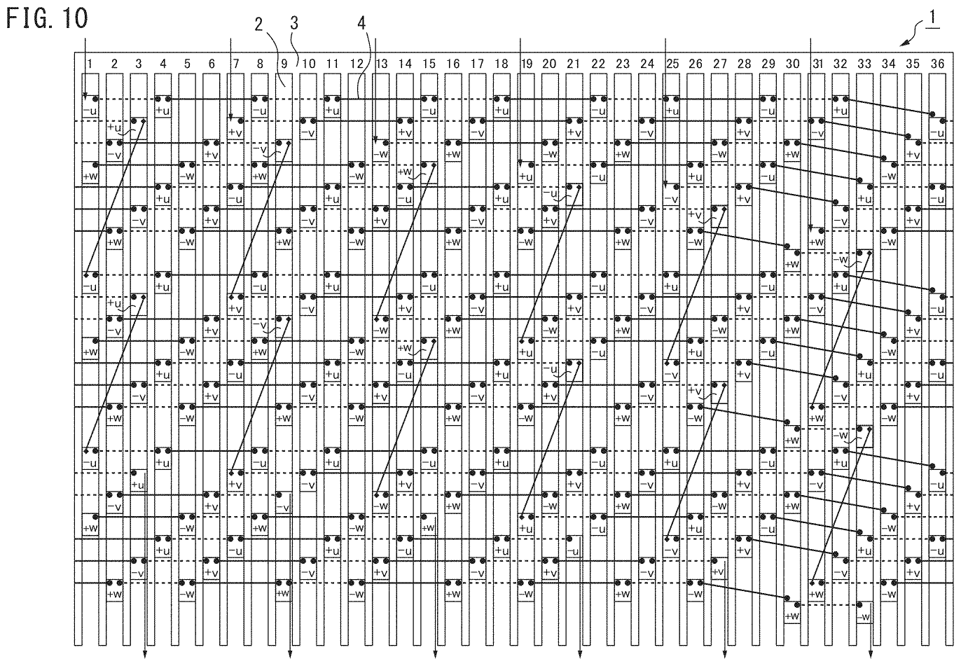

FIG. 10 is a developed sectional view (part 2) for explaining the configuration of a three-phase winding formed by the groups of coils of the stator illustrated in FIGS. 1 to 8. Referring to FIG. 10, a coil arrangement corresponding to the 36 slots is illustrated in two rows (i.e., slot identification numbers 1 to 18 and slot identification numbers 19 to 36), for the sake of drawing simplicity and clarity. When each group of coils of the stator 1 in the 10-pole, 36-slot three-phase AC motor illustrated in FIGS. 1 to 8 is disposed as three groups of coils to span 360 degrees each, the first to sixth groups of coils are provided as three first groups of coils to three sixth groups of coils, respectively. For example, for the three first groups of coils, coils with the slot having slot identification number 1 as the position of the start of winding are connected to each other via a crossover line, and coils with the slot having slot identification number 3 as the position of the end of winding are connected to each other via a crossover line. For the three second groups of coils, coils with the slot having slot identification number 7 as the position of the start of winding are connected to each other via a crossover line, and coils with the slot having slot identification number 9 as the position of the end of winding are connected to each other via a crossover line. For the three third groups of coils, coils with the slot having slot identification number 13 as the position of the start of winding are connected to each other via a crossover line, and coils with the slot having slot identification number 15 as the position of the end of winding are connected to each other via a crossover line. For the three fourth groups of coils, coils with the slot having slot identification number 19 as the position of the start of winding are connected to each other via a crossover line, and coils with the slot having slot identification number 21 as the position of the end of winding are connected to each other via a crossover line. For the three fifth groups of coils, coils with the slot having slot identification number 25 as the position of the start of winding are connected to each other via a crossover line, and coils with the slot having slot identification number 27 as the position of the end of winding are connected to each other via a crossover line. For the three sixth groups of coils, coils with the slot having slot identification number 31 as the position of the start of winding are connected to each other via a crossover line, and coils with the slot having slot identification number 33 as the position of the end of winding are connected to each other via a crossover line. First-phase windings (e.g., U-phase windings) in the stator 1 can be formed by connecting the above-mentioned three first groups of coils and three fourth groups of coils to each other via a crossover line. Second-phase windings (e.g., V-phase windings) in the stator 1 can be formed by connecting the above-mentioned three second groups of coils and three fifth groups of coils to each other via a crossover line. Third-phase windings (e.g., W-phase windings) in the stator 1 can be formed by connecting the above-mentioned three third groups of coils and three sixth groups of coils to each other via a crossover line.

In the embodiment according to the above-mentioned 10-pole, 36-slot three-phase AC motor, a three-phase winding is formed by individually disposing the first to sixth groups of coils in the slots, and connecting the individual groups of coils to each other via crossover lines. As a modification to this embodiment, a three-phase winding may be formed by disposing one winding in the slots in a pattern drawn with a single line, cutting the winding at positions to individually segment the first to sixth groups of coils to form the first to sixth groups of coils, and then connecting the individual groups of coils to each other via crossover lines. An example will be given below for details of this configuration.

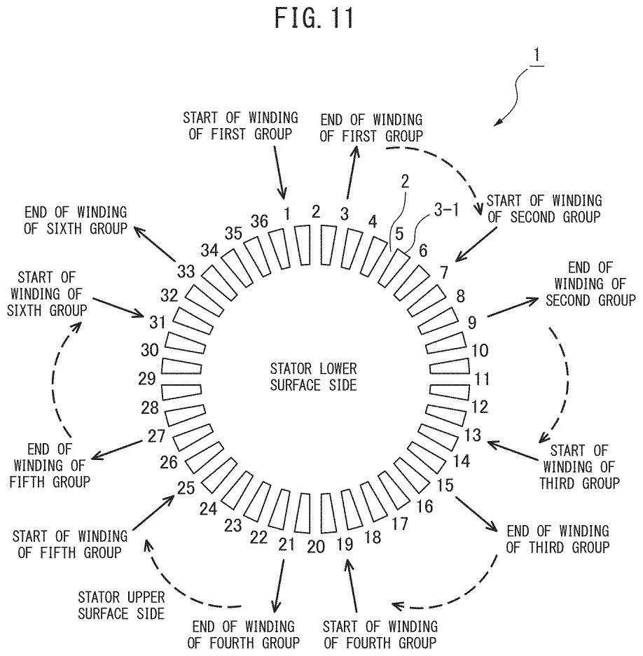

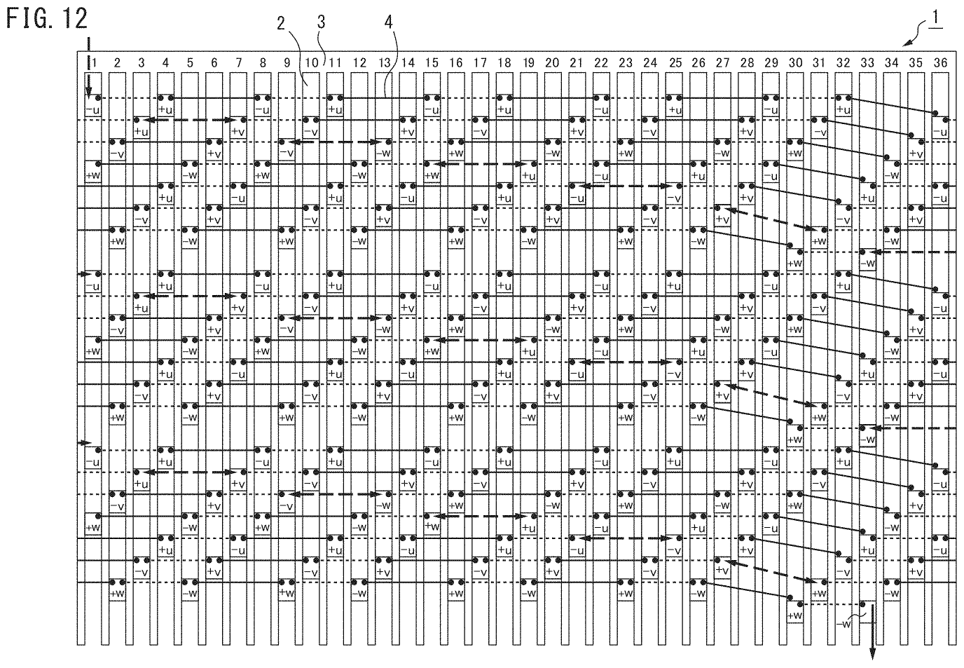

FIG. 11 is a diagram illustrating a schematic circle representing groups of coils formed by windings disposed in a pattern drawn with a single line in the stator of the 10-pole, 36-slot three-phase AC motor according to the embodiment of the present disclosure. FIG. 12 is a developed sectional view for explaining the groups of coils formed by the windings disposed in the pattern drawn with a single line in the stator of the 10-pole, 36-slot three-phase AC motor according to the embodiment of the present disclosure.

The coil is inserted from the stator upper surface side to the stator lower surface side of the slot having slot identification number 1, is disposed in the slots to alternately repeat a slot pitch of 3 and a slot pitch of 4 and span 360 degrees clockwise, as described above, and is inserted from the stator lower surface side to the stator upper surface side of the slot having slot identification number 3. With this operation, a portion corresponding to the first group of coils is formed. The coil (indicated by a dotted arrow in FIG. 11, and a bold broken line in FIG. 12) led from the stator upper surface side of the slot having slot identification number 3 is further inserted from the stator upper surface side to the stator lower surface side of the slot having slot identification number 7, is disposed in the slots to alternately repeat a slot pitch of 3 and a slot pitch of 4 and span 360 degrees clockwise, as described above, and is inserted from the stator lower surface side to the stator upper surface side of slot identification number 9. With this operation, a portion corresponding to the second group of coils is formed. The coil (indicated by a dotted arrow in FIG. 11, and a bold broken line in FIG. 12) led from the stator upper surface side of the slot having slot identification number 9 is further inserted from the stator upper surface side to the stator lower surface side of the slot having slot identification number 13, is disposed in the slots to alternately repeat a slot pitch of 3 and a slot pitch of 4 and span 360 degrees clockwise, as described above, and is inserted from the stator lower surface side to the stator upper surface side of slot identification number 15. With this operation, a portion corresponding to the third group of coils is formed. The coil (indicated by a dotted arrow in FIG. 11, and a bold broken line in FIG. 12) led from the stator upper surface side of the slot having slot identification number 15 is further inserted from the stator upper surface side to the stator lower surface side of the slot having slot identification number 19, is disposed in the slots to alternately repeat a slot pitch of 3 and a slot pitch of 4 and span 360 degrees clockwise, as described above, and is inserted from the stator lower surface side to the stator upper surface side of slot identification number 21. With this operation, a portion corresponding to the fourth group of coils is formed. The coil (indicated by a dotted arrow in FIG. 11, and a bold broken line in FIG. 12) led from the stator upper surface side of the slot having slot identification number 21 is further inserted from the stator upper surface side to the stator lower surface side of the slot having slot identification number 25, is disposed in the slots to alternately repeat a slot pitch of 3 and a slot pitch of 4 and span 360 degrees clockwise, as described above, and is inserted from the stator lower surface side to the stator upper surface side of slot identification number 27. With this operation, a portion corresponding to the fifth group of coils is formed. The coil (indicated by a dotted arrow in FIG. 11, and a bold broken line in FIG. 12) led from the stator upper surface side of the slot having slot identification number 27 is further inserted from the stator upper surface side to the stator lower surface side of the slot having slot identification number 31, is disposed in the slots to alternately repeat a slot pitch of 3 and a slot pitch of 4 and span 360 degrees clockwise, as described above, and is inserted from the stator lower surface side to the stator upper surface side of slot identification number 33.

In this manner, one continuous winding can be obtained by inserting one winding from the stator upper surface side of the slot having slot identification number 1, disposing this winding in a pattern drawn with a single line in accordance with the above-mentioned procedure, and finally leading this winding out of the slot having slot identification number 33 from the stator upper surface side. The winding disposed in this pattern is then cut at a coil portion led from the stator upper surface side of the slot having slot identification number 3 (a position corresponding to the end of winding of the first group of coils) and inserted from the stator upper surface side of the slot having slot identification number 7 (a position corresponding to the start of winding of the second group of coils), a coil portion led from the stator upper surface side of the slot having slot identification number 9 (a position corresponding to the end of winding of the second group of coils) and inserted from the stator upper surface side of the slot having slot identification number 13 (a position corresponding to the start of winding of the third group of coils), a coil portion led from the stator upper surface side of the slot having slot identification number 15 (a position corresponding to the end of winding of the third group of coils) and inserted from the stator upper surface side of the slot having slot identification number 19 (a position corresponding to the start of winding of the fourth group of coils), a coil portion led from the stator upper surface side of the slot having slot identification number 21 (a position corresponding to the end of winding of the fourth group of coils) and inserted from the stator upper surface side of the slot having slot identification number 25 (a position corresponding to the start of winding of the fifth group of coils), and a coil portion led from the stator upper surface side of the slot having slot identification number 27 (a position corresponding to the end of winding of the fifth group of coils) and inserted from the stator upper surface side of the slot having slot identification number 31 (a position corresponding to the start of winding of the sixth group of coils). With this operation, the first to sixth groups of coils are individually segmented to form the first to sixth groups of coils.

After that, a three-phase winding is formed by connecting the first to sixth groups of coils segmented in the above-mentioned way to each other via crossover lines in the following way: First-phase windings (e.g., U-phase windings) in the stator 1 are formed by connecting the first group of coils and the fourth group of coils to each other via a crossover line. Second-phase windings (e.g., V-phase windings) in the stator 1 are formed by connecting the second group of coils and the fifth group of coils to each other via a crossover line. Third-phase windings (e.g., W-phase windings) in the stator 1 are formed by connecting the third group of coils and the sixth group of coils to each other via a crossover line.

The 10-pole, 36-slot three-phase AC motor includes the stator 1 described above, and a rotor facing the stator 1 in the radial direction.

The line symmetry of the arrangement of groups of coils that holds in a stator for a fractional-slot three-phase AC motor in which the number of poles 2P is an odd multiple of 2 (i.e., the number of pole pairs P is an odd number) will be described below.

When the number of poles on the rotor is an odd multiple of 2 (i.e., the number of pole pairs is an odd number), line symmetry holds for the arrangement of the six groups of coils. Line symmetry holds for the arrangement of the six groups of coils. In the 10-pole, 36-slot three-phase AC motor illustrated in FIGS. 1 to 12, since the number of poles of 10 is five times 2 (i.e., an odd multiple of 2), line symmetry holds.

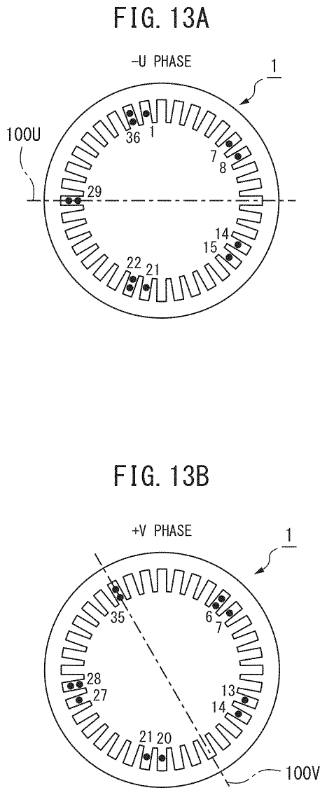

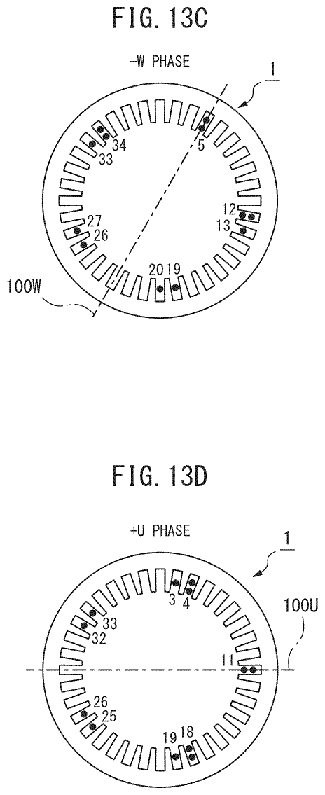

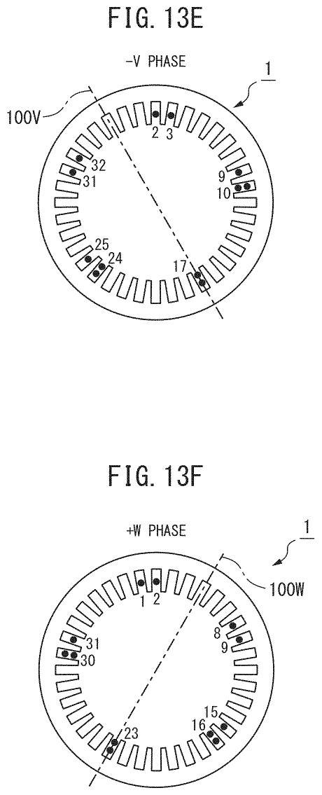

FIG. 13A is a sectional view for explaining the line symmetry of the winding arrangement of the stator in the 10-pole, 36-slot three-phase AC motor illustrated in FIGS. 1 to 12, and depicts −U-phase windings. FIG. 13B is a sectional view for explaining the line symmetry of the winding arrangement of the stator in the 10-pole, 36-slot three-phase AC motor illustrated in FIGS. 1 to 12, and depicts +V-phase windings. FIG. 13C is a sectional view for explaining the line symmetry of the winding arrangement of the stator in the 10-pole, 36-slot three-phase AC motor illustrated in FIGS. 1 to 12, and depicts −W-phase windings. FIG. 13D is a sectional view for explaining the line symmetry of the winding arrangement of the stator in the 10-pole, 36-slot three-phase AC motor illustrated in FIGS. 1 to 12, and depicts +U-phase windings. FIG. 13E is a sectional view for explaining the line symmetry of the winding arrangement of the stator in the 10-pole, 36-slot three-phase AC motor illustrated in FIGS. 1 to 12, and depicts −V-phase windings. FIG. 13F is a sectional view for explaining the line symmetry of the winding arrangement of the stator in the 10-pole, 36-slot three-phase AC motor illustrated in FIGS. 1 to 12, and depicts +W-phase windings.

As illustrated in FIG. 13A, −U-phase windings are disposed in the slots having slot identification numbers 1, 7, 8, 14, 15, 21, 22, 29, and 36. The −U-phase windings are arranged in line symmetry with respect to a first axis of symmetry 100U on the circumferential plane.

As illustrated in FIG. 13B, +V-phase windings are disposed in the slots having slot identification numbers 6, 7, 13, 14, 20, 21, 27, 28, and 35. The +V-phase windings are arranged in line symmetry with respect to a second axis of symmetry 100V on the circumferential plane.

As illustrated in FIG. 13C, −W-phase windings are disposed in the slots having slot identification numbers 5, 12, 13, 19, 20, 26, 27, 33, and 34. The −W-phase windings are arranged in line symmetry with respect to a third axis of symmetry 100W on the circumferential plane.

As illustrated in FIG. 13D, +U-phase windings are disposed in the slots having slot identification numbers 3, 4, 11, 18, 19, 25, 26, 32, and 33. The +U-phase windings are arranged in line symmetry with respect to the first axis of symmetry 100U on the circumferential plane.

As illustrated in FIG. 13E, −V-phase windings are disposed in the slots having slot identification numbers 2, 3, 9, 10, 17, 24, 25, 31, and 32. The −V-phase windings are arranged in line symmetry with respect to the second axis of symmetry 100V on the circumferential plane.

As illustrated in FIG. 13F, +-phase windings are disposed in the slots having slot identification numbers 1, 2, 8, 9, 15, 16, 23, 30, and 31. The +W-phase windings are arranged in line symmetry with respect to the third axis of symmetry 100W on the circumferential plane.

As illustrated in FIGS. 13A to 13F, in the stator 1 of the 10-pole, 36-slot three-phase AC motor, for the windings of the same phase belt, the slot pitch to an adjacent winding is 50 degrees at five positions and 10 degrees at three positions. In other words, in a stator for a fractional-slot three-phase AC motor in which the value obtained by dividing the number of slots by the number of poles takes an irreducible fraction, the winding arrangement has windings that are not distributed at equal angles, i.e., has no rotational symmetry. When the number of pole pairs P is an odd number of 5 or more, an axis of line symmetry is always present. This is for the following reason.

For each of the six phase belts: ±U, ±V, and ±W, when the winding arrangement is optimized to approximate the waveform of an induced voltage generated in the coils of the stator to a sinusoidal wave, the windings of each phase belt are arranged in a uniform distribution at a slot pitch close to the value of 360/(Number of Pole Pairs P), and are therefore arranged in a shape close to a regular P-sided polygon (where P is the number of pole pairs).

Generally, when the number of pole pairs P is an odd number, the regular P-sided polygon has not only P-fold rotational symmetry, but also line symmetry with respect to a perpendicular line passing from each vertex to the center of the opposite side of this vertex.

When windings of one phase among the six phase belts: ±U, ±V, and ±W are disposed in slots of a fractional-slot stator, they are arranged in a shape close to a regular P-sided polygon having P vertices, where P is an odd number. The winding arrangement may not have rotational symmetry, but since “P−1” always takes an even number, (P−1)/2 continuous vertices and (P−1)/2 consecutive vertices adjacent to the first vertices are arranged in line symmetry, except a certain vertex of the P vertices. The line of line symmetry passes through the remaining vertex.

The 10-pole, 36-slot three-phase AC motor will be taken as an example herein with reference to FIG. 13A. −U-phase windings are disposed in a total of nine slots having slot identification numbers 1, 7, 8, 14, 15, 21, 22, 29, and 36. The arrangement of the nine −U-phase windings forms a shape close to a regular pentagon assuming each of the sets of adjacent slots having slot identification numbers 1 and 36, 7 and 8, 14 and 15, and 21 and 22 as one combined winding.

Since the number of pole pairs on the rotor for the −U-phase windings is 5, the period of one pole pair corresponding to 360 electrical degrees corresponds to 360/5=72 mechanical degrees. Since the number of slots is 36, a slot pitch of 1 is equivalent to 360/36=10 degrees. The slot pitch from one −U-phase winding to an adjacent −U-phase winding is desirably set to 72 mechanical degrees corresponding to one period of the electrical angle. The slot pitch, however, can be set to only 10 degrees corresponding to one slot between slot identification numbers 1 and 36, slot identification numbers 7 and 8, slot identification numbers 14 and 15, and slot identification numbers 21 and 22. The slot pitch can further be set to only 50 degrees corresponding to five slots between slot identification numbers 1 and 7, slot identification numbers 8 and 14, and slot identification numbers 15 and 21. Therefore, the −U-phase winding arrangement has no rotational symmetry. From distribution uniformity of the windings, two windings disposed in the slots having slot identification numbers 1 and 36 and two windings disposed in the slots having slot identification numbers 21 and 22 among the nine −U-phase windings are arranged in line symmetry with respect to 100U as an axis of line symmetry. The axis of line symmetry 100U also serves as the axis of line symmetry between two windings disposed in the slots having slot identification numbers 7 and 8 and two windings disposed in the slots having slot identification numbers 14 and 15, and, as a consequence, can be said to be an axis of line symmetry bisecting the nine −U-phase windings. For the same reason, the winding arrangements of the remaining five phase belts have no rotational symmetry, but they have axes of line symmetry as well. In the 10-pole, 36-slot three-phase AC motor, further, the axis of line symmetry 100U for the −U and +U phases, the axis of line symmetry 100V for the −V and +V phases, and the axis of line symmetry 100W for the −W and +W phases coincide with lines dividing the groups of coils.

The above-described line symmetry of the windings can be summarized as follows: U-phase windings are arranged to have one axis of line symmetry, V-phase windings are arranged to have one axis of line symmetry, and W-phase windings are arranged to have one axis of line symmetry. In other words, U-phase windings are arranged in line symmetry with respect to the axis of line symmetry 100U, V-phase windings are arranged in line symmetry with respect to the axis of line symmetry 100V, and W-phase windings are arranged in line symmetry with respect to the axis of line symmetry 100W. The first axis of symmetry 100U, the second axis of symmetry 100V, and the third axis of symmetry 100W are shifted from each other by 60 degrees. This is a feature of a three-phase AC motor in which the number of pole pairs P is an odd number, and the value obtained by dividing the number of slots by the number of poles takes an irreducible fraction. Since all the six phase belts: the −U, +U, −V, +V, −W, and +W are arranged in line symmetry, each of these six phase belts always has an even number of windings, excluding the winding on the corresponding axis of line symmetry. The windings on each axis of line symmetry are located so that the positive winding (+ winding) and the negative winding (− winding) of each phase on the corresponding axis of line symmetry are 180-degree opposite to each other, and are thus symmetrical with respect to each other. Therefore, by appropriately determining a combination of negative windings (− windings) and positive windings (+ windings) for each phase, the negative windings (− windings) and the positive windings (+ windings) of this phase can be divided into two groups of coils while maintaining line symmetry. In, e.g., the 10-pole, 36-slot three-phase AC motor, the −U-phase windings in FIG. 13A and the +U-phase windings in FIG. 13D can form the first group of coils and the fourth group of coils in FIG. 8, the −V-phase windings in FIG. 13B and the +V-phase windings in FIG. 13E can form the second group of coils and the fifth group of coils in FIG. 8, and the −W-phase windings in FIG. 13C and the +W-phase windings in FIG. 13F can form the third group of coils and the sixth group of coils in FIG. 8.

A stator in a 10-pole, 24-slot three-phase AC motor will be described below.

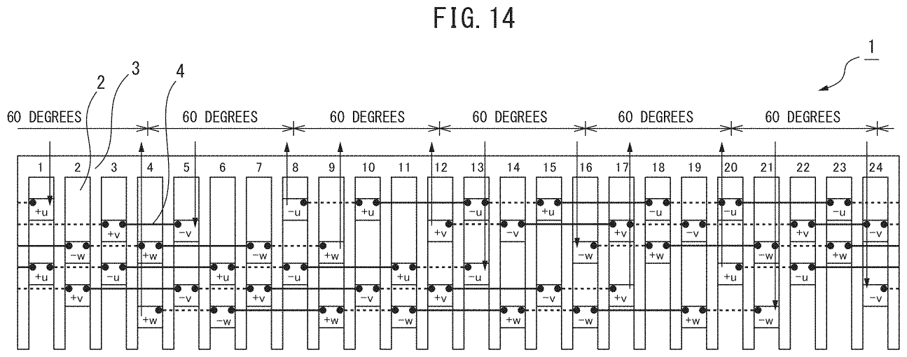

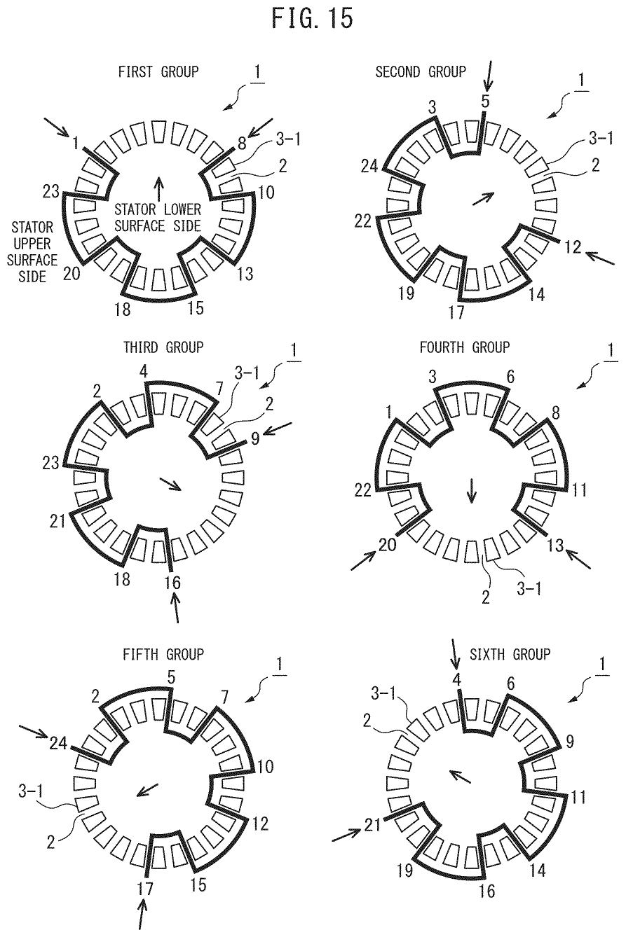

FIG. 14 is a developed sectional view illustrating the coil arrangement of a stator in a 10-pole, 24-slot three-phase AC motor according to an embodiment of the present disclosure. FIG. 15 is a diagram illustrating schematic circles representing the coil arrangements of groups of coils in the stator illustrated in FIG. 14.

In the 10-pole, 24-slot three-phase AC motor, since the value obtained by dividing the number of slots of 24 by the number of poles of 10 is 2.4, the motor satisfies the requirement “the number of slots is larger than 1.5 times the number of poles.” In addition, since 12/5 taken as the value obtained by dividing the number of slots of 24 by the number of poles of 10 is an irreducible fraction, the motor can be said to be of the fractional slot type.

In the 10-pole, 24-slot three-phase AC motor, since the quotient, that is, the decimal integer part of the value obtained by dividing the number of slots of 24 by the number of poles of 10 is 2, the stator 1 is provided with six groups of coils formed by the coils 4 arranged in the slots 2 by wave winding at a slot pitch of 2 or 3(=2+1). The six groups of coils are shifted in position from each other by 60 degrees in the circumferential direction.

Especially the 10-pole, 24-slot three-phase AC motor can be provided with groups of coils formed by coils of wave winding arranged in the slots 2 to alternately repeat a slot pitch of 2 and a slot pitch of 3. For example, coil ends corresponding to a slot pitch of 3 are exposed on the stator upper surface side, and coil ends corresponding to a slot pitch of 2 are exposed on the stator lower surface side. Further, 5 taken as the value obtained by summing the respective numbers of slot pitches, that is, the slot pitch of 2 and the slot pitch of 3 corresponds to a slot pitch for approximately every two poles (one pole pair). The value obtained by multiplying this value of 5 by the number of pole pairs of 5 (the value obtained by dividing the number of poles of 10) is 25, which does not match the total number of slots of 24, and, therefore, even when wave winding is performed around the slots of the stator alternately at a slot pitch of 2 and a slot pitch of 3 to span 360 degrees, no return to the original position (the position of the start of winding) is made. This feature is obtained because 5 taken as the value obtained by summing the respective numbers of slot pitches, that is, the slot pitch of 2 and the slot pitch of 3, and the number of slots of 24 are relatively prime.

As illustrated in FIGS. 14 and 15, in the first group of coils, the coil is inserted from the stator upper surface side to the stator lower surface side of the slot having slot identification number 1, and inserted from the stator lower surface side to the stator upper surface side of the slot having slot identification number 23 shifted from that having slot identification number 1 by a slot pitch of 2 counterclockwise. The coil is further inserted from the stator upper surface side to the stator lower surface side of the slot having slot identification number 20 shifted from that having slot identification number 23 by a slot pitch of 3 counterclockwise, and inserted from the stator lower surface side to the stator upper surface side of the slot having slot identification number 18 shifted from that having slot identification number 20 by a slot pitch of 2 counterclockwise. The coil is further inserted from the stator upper surface side to the stator lower surface side of the slot having slot identification number 15 shifted from that having slot identification number 18 by a slot pitch of 3 counterclockwise, and inserted from the stator lower surface side to the stator upper surface side of the slot having slot identification number 13 shifted from that having slot identification number 15 by a slot pitch of 2 counterclockwise. The coil is further inserted from the stator upper surface side to the stator lower surface side of the slot having slot identification number 10 shifted from that having slot identification number 13 by a slot pitch of 3 counterclockwise, and inserted from the stator lower surface side to the stator upper surface side of the slot having slot identification number 8 shifted from that having slot identification number 10 by a slot pitch of 2 counterclockwise. In this manner, in the first group of coils, the slot having slot identification number 1 is set as the position of the start of winding, and the slot having slot identification number 8 shifted from the slot having slot identification number 1 to come nearly full circle counterclockwise is set as the position of the end of winding. The thus disposed first group of coils forms a half of first-phase windings (e.g., U-phase windings).

The second to sixth groups of coils are similarly formed by coils of wave winding arranged in the slots 2 to alternately repeat a slot pitch of 2 and a slot pitch of 3.

As illustrated in FIGS. 14 and 15, the second group of coils is shifted in position from the first group of coils by 60 degrees in the circumferential direction (in the example illustrated in FIGS. 14 and 15, clockwise). In other words, the slot having slot identification number 5 shifted from the slot having slot identification number 1, that is, from the position of the start of winding of the first group of coils by a slot pitch of 4 (60 degrees) clockwise is set as the position of the start of winding of the second group of coils. When winding is performed around the slots from this position of the start of winding to alternately repeat a slot pitch of 2 and a slot pitch of 3 counterclockwise, the slot having identification number 12 shifted from that having identification number 8, that is, from the position of the end of winding of the first group of coils by a slot pitch of 4 clockwise is set as the position of the end of winding of the second group of coils. The thus disposed second group of coils forms a half of second-phase windings (e.g., V-phase windings).

As illustrated in FIGS. 14 and 15, the third group of coils is shifted in position from the second group of coils by 60 degrees in the circumferential direction (in the example illustrated in FIGS. 14 and 15, clockwise). In other words, the slot having slot identification number 16 shifted from the slot having slot identification number 12, that is, from the position of the start of winding of the second group of coils by a slot pitch of 4 (60 degrees) clockwise is set as the position of the start of winding of the third group of coils. When winding is performed around the slots from this position of the start of winding to alternately repeat a slot pitch of 2 and a slot pitch of 3 counterclockwise, the slot having identification number 16 shifted from that having identification number 12, that is, from the position of the end of winding of the second group of coils by a slot pitch of 4 clockwise is set as the position of the end of winding of the third group of coils. The thus disposed third group of coils forms a half of third-phase windings (e.g., W-phase windings).

As illustrated in FIGS. 14 and 15, the fourth group of coils is shifted in position from the third group of coils by 60 degrees in the circumferential direction (in the example illustrated in FIGS. 14 and 15, clockwise). In other words, the slot having slot identification number 20 shifted from the slot having slot identification number 16, that is, from the position of the start of winding of the third group of coils by a slot pitch of 4 (60 degrees) clockwise is set as the position of the start of winding of the fourth group of coils. When winding is performed around the slots from this position of the start of winding to alternately repeat a slot pitch of 2 and a slot pitch of 3 counterclockwise, the slot having identification number 20 shifted from that having identification number 16, that is, from the position of the end of winding of the third group of coils by a slot pitch of 4 clockwise is set as the position of the end of winding of the fourth group of coils. The thus disposed fourth group of coils forms the remaining half of the first-phase windings (e.g., U-phase windings).

As illustrated in FIGS. 14 and 15, the fifth group of coils is shifted in position from the fourth group of coils by 60 degrees in the circumferential direction (in the example illustrated in FIGS. 14 and 15, clockwise). In other words, the slot having slot identification number 24 shifted from the slot having slot identification number 20, that is, from the position of the start of winding of the fourth group of coils by a slot pitch of 4 (60 degrees) clockwise is set as the position of the start of winding of the fifth group of coils. When winding is performed around the slots from this position of the start of winding to alternately repeat a slot pitch of 2 and a slot pitch of 3 counterclockwise, the slot having identification number 24 shifted from that having identification number 20, that is, from the position of the end of winding of the fourth group of coils by a slot pitch of 4 clockwise is set as the position of the end of winding of the fifth group of coils. The thus disposed fifth group of coils forms the remaining half of the second-phase windings (e.g., V-phase windings).

As illustrated in FIGS. 14 and 15, the sixth group of coils is shifted in position from the fifth group of coils by 60 degrees in the circumferential direction (in the example illustrated in FIGS. 14 and 15, clockwise). In other words, the slot having slot identification number 4 shifted from the slot having slot identification number 24, that is, from the position of the start of winding of the fifth group of coils by a slot pitch of 4 (60 degrees) clockwise is set as the position of the start of winding of the sixth group of coils. When winding is performed around the slots from this position of the start of winding to alternately repeat a slot pitch of 2 and a slot pitch of 3 counterclockwise, the slot having identification number 4 shifted from that having identification number 24, that is, from the position of the end of winding of the fifth group of coils by a slot pitch of 4 clockwise is set as the position of the end of winding of the sixth group of coils. The thus disposed sixth group of coils forms the remaining half of the third-phase windings (e.g., W-phase windings).

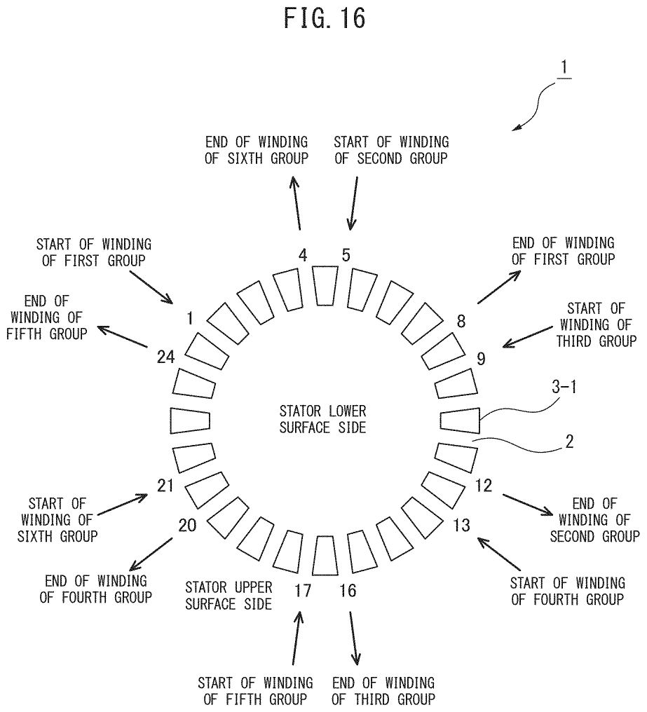

FIG. 16 is a diagram illustrating a schematic circle representing the positions of the start and the start of winding of the groups of coils in the stator illustrated in FIGS. 14 and 15.

In the stator 1 of the 10-pole, 24-slot three-phase AC motor illustrated in FIGS. 14 and 15, in the first group of coils, the slot having slot identification number 1 is set as the position of the start of winding, and the slot having slot identification number 8 shifted from the slot having slot identification number 1 to come nearly full circle counterclockwise is set as the position of the end of winding. In the second group of coils, the slot having slot identification number 5 is set as the position of the start of winding, and the slot having slot identification number 12 shifted from the slot having slot identification number 5 to come nearly full circle counterclockwise is set as the position of the end of winding. In the third group of coils, the slot having slot identification number 9 is set as the position of the start of winding, and the slot having slot identification number 16 shifted from the slot having slot identification number 9 to come nearly full circle counterclockwise is set as the position of the end of winding. In the fourth group of coils, the slot having slot identification number 13 is set as the position of the start of winding, and the slot having slot identification number 20 shifted from the slot having slot identification number 13 to come nearly full circle counterclockwise is set as the position of the end of winding. In the fifth group of coils, the slot having slot identification number 17 is set as the position of the start of winding, and the slot having slot identification number 24 shifted from the slot having slot identification number 17 to come nearly full circle counterclockwise is set as the position of the end of winding. In the sixth group of coils, the slot having slot identification number 21 is set as the position of the start of winding, and the slot having slot identification number 4 shifted from the slot having slot identification number 21 to come nearly full circle counterclockwise is set as the position of the end of winding.

For example, the first group of coils forms a half of first-phase windings (e.g., U-phase windings), and the fourth group of coils forms the remaining half of the first-phase windings (e.g., U-phase windings). First-phase windings (e.g., U-phase windings) in the stator 1 can be formed by connecting the first group of coils and the fourth group of coils to each other via a crossover line. The second group of coils forms a half of second-phase windings (e.g., V-phase windings), and the fifth group of coils forms the remaining half of the second-phase windings (e.g., V-phase windings). Second-phase windings (e.g., V-phase windings) in the stator 1 can be formed by connecting the second group of coils and the fifth group of coils to each other via a crossover line. The third group of coils forms a half of third-phase windings (e.g., W-phase windings), and the sixth group of coils forms the remaining half of the third-phase windings (e.g., W-phase windings). Third-phase windings (e.g., W-phase windings) in the stator 1 can be formed by connecting the third group of coils and the sixth group of coils to each other via a crossover line. In this manner, a three-phase winding can be formed by individually disposing the first to sixth groups of coils in the slots, and connecting the individual groups of coils to each other via crossover lines in the above-mentioned way. In the 10-pole, 24-slot three-phase AC motor as well, a three-phase winding may be formed by forming the first to sixth groups of coils as a plurality of first groups of coils to a plurality of sixth groups of coils, respectively, like the 10-pole, 36-slot three-phase AC motor.

In the embodiment according to the above-mentioned 10-pole, 24-slot three-phase AC motor, a three-phase winding is formed by individually disposing the first to sixth groups of coils in the slots, and connecting the individual groups of coils to each other via crossover lines. As a modification to this embodiment, a three-phase winding may be formed by disposing one winding in the slots in a pattern drawn with a single line, cutting the winding at positions to individually segment the first to sixth groups of coils to form the first to sixth groups of coils, and then connecting the individual groups of coils to each other via crossover lines. An example will be given below for details of this configuration.

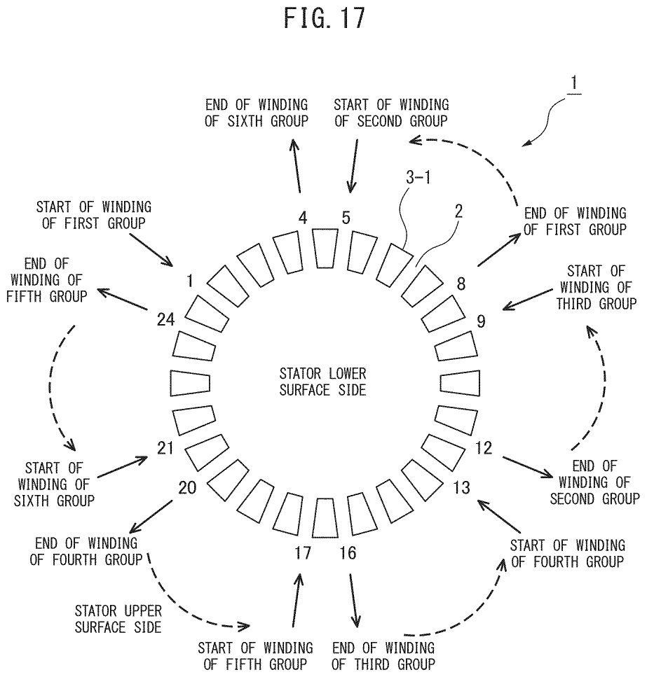

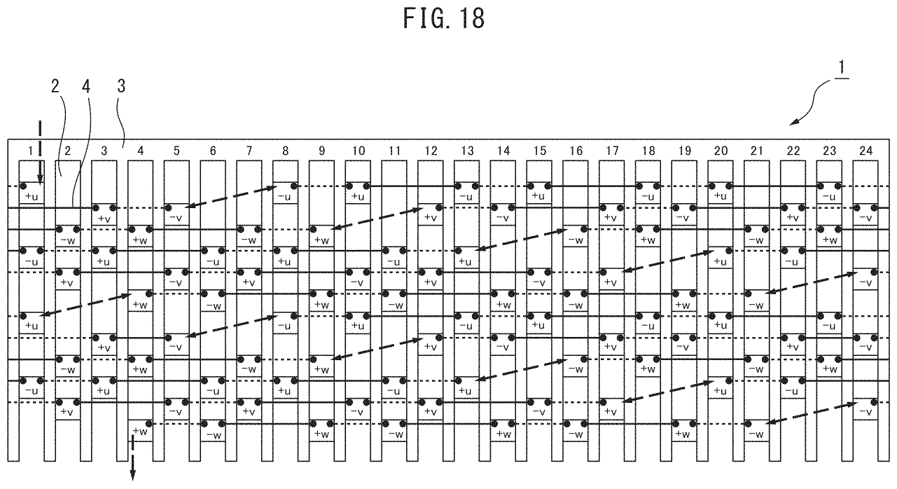

FIG. 17 is a diagram illustrating a schematic circle representing groups of coils formed by windings disposed in a pattern drawn with a single line in the stator of the 10-pole, 24-slot three-phase AC motor according to the embodiment of the present disclosure. FIG. 18 is a developed sectional view for explaining the groups of coils formed by the windings disposed in the pattern drawn with a single line in the stator of the 10-pole, 24-slot three-phase AC motor according to the embodiment of the present disclosure.

In the stator of the 10-pole, 24-slot three-phase AC motor described with reference to FIGS. 14 to 16, the windings are disposed in the slots clockwise, while in the stator of the 10-pole, 24-slot three-phase AC motor to be described with reference to FIGS. 17 and 18, the windings are disposed in the slots in a pattern drawn with a single line counterclockwise. An example in which each group of coils of the stator 1 in the 10-pole, 24-slot three-phase AC motor is disposed in a pattern drawn with a single line as two groups of coils to span 360 degrees each will be given herein. The first to sixth groups of coils are provided as two first groups of coils to two sixth groups of coils, respectively.

A portion corresponding to the first to sixth groups of coils of the first set is formed first in a pattern drawn with a single line.

The coil is inserted from the stator upper surface side to the stator lower surface side of the slot having slot identification number 1, is disposed in the slots counterclockwise to alternately repeat a slot pitch of 2 and a slot pitch of 3, as described above, and is inserted from the stator lower surface side to the stator upper surface side of the slot having slot identification number 8. With this operation, a portion corresponding to the first group of coils is formed. The coil led from the stator upper surface side of the slot having slot identification number 8 is further inserted from the stator upper surface side to the stator lower surface side of the slot having slot identification number 5, is disposed in the slots counterclockwise to alternately repeat a slot pitch of 2 and a slot pitch of 3, as described above, and is inserted from the stator lower surface side to the stator upper surface side of slot identification number 12. With this operation, a portion corresponding to the second group of coils is formed. The coil led from the stator upper surface side of the slot having slot identification number 12 is further inserted from the stator upper surface side to the stator lower surface side of the slot having slot identification number 9, is disposed in the slots counterclockwise to alternately repeat a slot pitch of 2 and a slot pitch of 3, as described above, and is inserted from the stator lower surface side to the stator upper surface side of slot identification number 16. With this operation, a portion corresponding to the third group of coils is formed. The coil led from the stator upper surface side of the slot having slot identification number 16 is further inserted from the stator upper surface side to the stator lower surface side of the slot having slot identification number 13, is disposed in the slots counterclockwise to alternately repeat a slot pitch of 2 and a slot pitch of 3, as described above, and is inserted from the stator lower surface side to the stator upper surface side of slot identification number 20. With this operation, a portion corresponding to the fourth group of coils is formed. The coil led from the stator upper surface side of the slot having slot identification number 20 is further inserted from the stator upper surface side to the stator lower surface side of the slot having slot identification number 17, is disposed in the slots clockwise to alternately repeat a slot pitch of 2 and a slot pitch of 3, as described above, and is inserted from the stator lower surface side to the stator upper surface side of slot identification number 24. With this operation, a portion corresponding to the fifth group of coils is formed. The coil led from the stator upper surface side of the slot having slot identification number 24 is further inserted from the stator upper surface side to the stator lower surface side of the slot having slot identification number 21, is disposed in the slots counterclockwise to alternately repeat a slot pitch of 2 and a slot pitch of 3, as described above, and is inserted from the stator lower surface side to the stator upper surface side of slot identification number 4.

In this manner, one continuous winding can be obtained by inserting one winding from the stator upper surface side of the slot having slot identification number 1, disposing this winding counterclockwise in a pattern drawn with a single line in accordance with the above-mentioned procedure, and finally leading this winding out of the slot having slot identification number 21 from the stator upper surface side. The winding disposed in this pattern is then cut at a coil portion led from the stator upper surface side of the slot having slot identification number 8 (a position corresponding to the end of winding of the first group of coils) and inserted from the stator upper surface side of the slot having slot identification number 5 (a position corresponding to the start of winding of the second group of coils), a coil portion led from the stator upper surface side of the slot having slot identification number 12 (a position corresponding to the end of winding of the second group of coils) and inserted from the stator upper surface side of the slot having slot identification number 9 (a position corresponding to the start of winding of the third group of coils), a coil portion led from the stator upper surface side of the slot having slot identification number 16 (a position corresponding to the end of winding of the third group of coils) and inserted from the stator upper surface side of the slot having slot identification number 13 (a position corresponding to the start of winding of the fourth group of coils), a coil portion led from the stator upper surface side of the slot having slot identification number 20 (a position corresponding to the end of winding of the fourth group of coils) and inserted from the stator upper surface side of the slot having slot identification number 17 (a position corresponding to the start of winding of the fifth group of coils), and a coil portion led from the stator upper surface side of the slot having slot identification number 24 (a position corresponding to the end of winding of the fifth group of coils) and inserted from the stator upper surface side of the slot having slot identification number 21 (a position corresponding to the start of winding of the sixth group of coils). With this operation, the first to sixth groups of coils are individually segmented to form the first to sixth groups of coils.

After that, a three-phase winding is formed by connecting the first to sixth groups of coils segmented in the above-mentioned way to each other via crossover lines in the following way: First-phase windings (e.g., U-phase windings) in the stator 1 are formed by connecting the first group of coils and the fourth group of coils to each other via a crossover line. Second-phase windings (e.g., V-phase windings) in the stator 1 are formed by connecting the second group of coils and the fifth group of coils to each other via a crossover line. Third-phase windings (e.g., W-phase windings) in the stator 1 are formed by connecting the third group of coils and the sixth group of coils to each other via a crossover line.

The 10-pole, 24-slot three-phase AC motor includes the stator 1 described above, and a rotor facing the stator 1 in the radial direction.

A stator in an 8-pole, 30-slot three-phase AC motor will be described below.

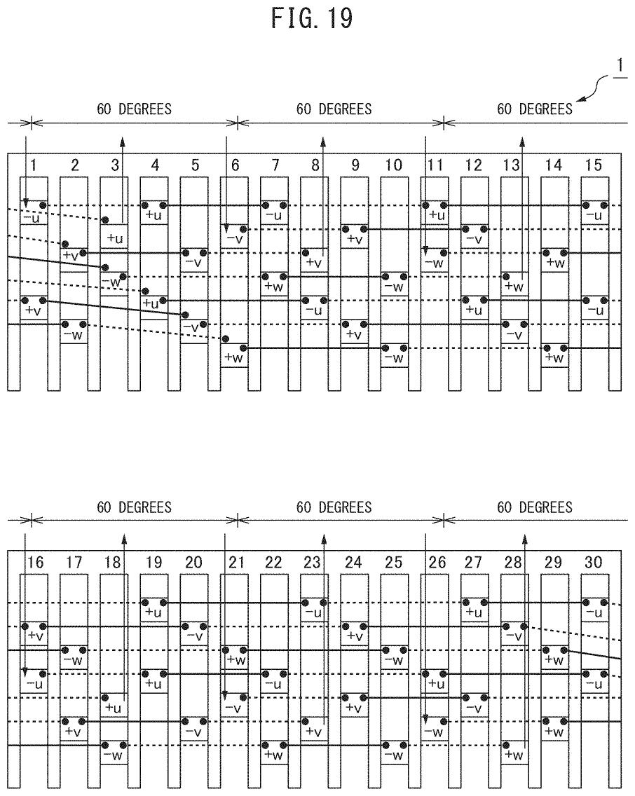

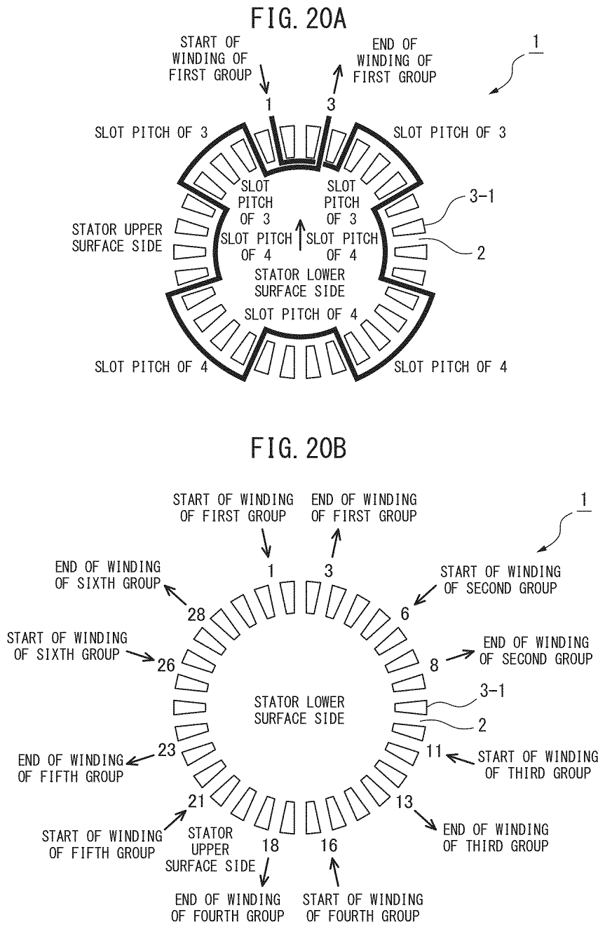

FIG. 19 is a developed sectional view illustrating the coil arrangement of a stator in an 8-pole, 30-slot three-phase AC motor according to an embodiment of the present disclosure. Referring to FIG. 19, a coil arrangement corresponding to the 30 slots is illustrated in two rows (i.e., slot identification numbers 1 to 15 and slot identification numbers 16 to 30), for the sake of drawing simplicity and clarity. FIG. 20A is a diagram illustrating a schematic circle representing the coil arrangement of groups of coils in the stator illustrated in FIG. 19, and depicts the arrangement of a first group of coils. FIG. 20B is a diagram illustrating a schematic circle representing the coil arrangement of the groups of coils in the stator illustrated in FIG. 19, and depicts a schematic circle representing the positions of the start and the start of winding of the groups of coils in the stator.

In the 8-pole, 30-slot three-phase AC motor, since the value obtained by dividing the number of slots of 30 by the number of poles of 8 is 3.75, the motor satisfies the requirement “the number of slots is larger than 1.5 times the number of poles.” In addition, since 15/4 taken as the value obtained by dividing the number of slots of 30 by the number of poles of 8 is an irreducible fraction, the motor can be said to be of the fractional slot type.

In the 8-pole, 30-slot three-phase AC motor, since the quotient, that is, the decimal integer part of the value obtained by dividing the number of slots of 30 by the number of poles of 8 is 3, the stator 1 is provided with six groups of coils formed by the coils 4 arranged in the slots 2 by wave winding at a slot pitch of 3 or 4(=3+1). The six groups of coils are shifted in position from each other by 60 degrees in the circumferential direction.

The 8-pole, 30-slot three-phase AC motor can be provided with groups of coils formed by coils of wave winding arranged in the slots 2 at a slot pitch of 3 or a slot pitch of 4. For example, coil ends corresponding to a slot pitch of 3 or a slot pitch of 4 are exposed on the stator upper surface side, and coil ends corresponding to a slot pitch of 3 or a slot pitch of 4 are exposed on the stator lower surface side.

As illustrated in FIGS. 19, 20A, and 20B, in the first group of coils, the coil is inserted from the stator upper surface side to the stator lower surface side of the slot having slot identification number 1, and inserted from the stator lower surface side to the stator upper surface side of the slot having slot identification number 4 shifted from that having slot identification number 2 by a slot pitch of 3. The coil is further inserted from the stator upper surface side to the stator lower surface side of the slot having slot identification number 7 shifted from that having slot identification number 4 by a slot pitch of 3, and inserted from the stator lower surface side to the stator upper surface side of the slot having slot identification number 11 shifted from that having slot identification number 7 by a slot pitch of 4. The coil is further inserted from the stator upper surface side to the stator lower surface side of the slot having slot identification number 15 shifted from that having slot identification number 11 by a slot pitch of 4, and inserted from the stator lower surface side to the stator upper surface side of the slot having slot identification number 19 shifted from that having slot identification number 15 by a slot pitch of 4. The coil is further inserted from the stator upper surface side to the stator lower surface side of the slot having slot identification number 23 shifted from that having slot identification number 19 by a slot pitch of 4, and inserted from the stator lower surface side to the stator upper surface side of the slot having slot identification number 27 shifted from that having slot identification number 23 by a slot pitch of 4. The coil is further inserted from the stator upper surface side to the stator lower surface side of the slot having slot identification number 30 shifted from that having slot identification number 27 by a slot pitch of 3, and inserted from the stator lower surface side to the stator upper surface side of the slot having slot identification number 3 shifted from that having slot identification number 30 by a slot pitch of 3. In this manner, in the first group of coils, the slot having slot identification number 1 is set as the position of the start of winding, and the slot having slot identification number 3 shifted from the slot having slot identification number 1 by 360 degrees clockwise plus an amount of two slots (24 degrees) clockwise is set as the position of the end of winding. The thus disposed first group of coils can be used as a half of first-phase windings (e.g., U-phase windings).

As described above, for the first group of coils, coils of wave winding are disposed at slot pitches of “3, 3, 4, 4, 4, 4, 4, 3, 3.” The second to sixth groups of coils are also formed by coils of wave winding having the same or similar slot pitches.

As illustrated in FIGS. 19, 20A, and 20B, the second group of coils is shifted in position from the first group of coils by 60 degrees in the circumferential direction (in the example illustrated in FIGS. 19, 20A, and 20B, clockwise). In other words, the slot having slot identification number 6 shifted from the slot having slot identification number 1, that is, from the position of the start of winding of the first group of coils by a slot pitch of 5 (60 degrees) is set as the position of the start of winding of the second group of coils. When winding is performed around the slots from this position of the start of winding at slot pitches of “3, 3, 4, 4, 4, 4, 4, 3, 3,” the slot having identification number 8 shifted from that having identification number 3, that is, from the position of the end of winding of the first group of coils by a slot pitch of 5 is set as the position of the end of winding of the second group of coils. The thus disposed second group of coils can be used as a half of second-phase windings (e.g., V-phase windings).

As illustrated in FIGS. 19, 20A, and 20B, the third group of coils is shifted in position from the second group of coils by 60 degrees in the circumferential direction (in the example illustrated in FIGS. 19, 20A, and 20B, clockwise). In other words, the slot having slot identification number 11 shifted from the slot having slot identification number 6, that is, from the position of the start of winding of the second group of coils by a slot pitch of 5 (60 degrees) is set as the position of the start of winding of the third group of coils. When winding is performed around the slots from this position of the start of winding at slot pitches of “3, 3, 4, 4, 4, 4, 4, 3, 3,” the slot having identification number 13 shifted from that having identification number 8, that is, from the position of the end of winding of the second group of coils by a slot pitch of 5 is set as the position of the end of winding of the third group of coils. The thus disposed third group of coils can be used as a half of third-phase windings (e.g., W-phase windings).

As illustrated in FIGS. 19, 20A, and 20B, the fourth group of coils is shifted in position from the third group of coils by 60 degrees in the circumferential direction (in the example illustrated in FIGS. 19, 20A, and 20B, clockwise). In other words, the slot having slot identification number 16 shifted from the slot having slot identification number 11, that is, from the position of the start of winding of the third group of coils by a slot pitch of 5 (60 degrees) is set as the position of the start of winding of the fourth group of coils. When winding is performed around the slots from this position of the start of winding at slot pitches of “3, 3, 4, 4, 4, 4, 4, 3, 3,” the slot having identification number 18 shifted from that having identification number 13, that is, from the position of the end of winding of the third group of coils by a slot pitch of 5 is set as the position of the end of winding of the fourth group of coils. The thus disposed fourth group of coils can be used as the remaining half of the first-phase windings (e.g., U-phase windings).

As illustrated in FIGS. 19, 20A, and 20B, the fifth group of coils is shifted in position from the fourth group of coils by 60 degrees in the circumferential direction (in the example illustrated in FIGS. 19, 20A, and 20B, clockwise). In other words, the slot having slot identification number 21 shifted from the slot having slot identification number 16, that is, from the position of the start of winding of the fourth group of coils by a slot pitch of 5 (60 degrees) is set as the position of the start of winding of the fifth group of coils. When winding is performed around the slots from this position of the start of winding at slot pitches of “3, 3, 4, 4, 4, 4, 4, 3, 3,” the slot having identification number 23 shifted from that having identification number 18, that is, from the position of the end of winding of the fourth group of coils by a slot pitch of 5 is set as the position of the end of winding of the fifth group of coils. The thus disposed fifth group of coils can be used as the remaining half of the second-phase windings (e.g., V-phase windings).

As illustrated in FIGS. 19, 20A, and 20B, the sixth group of coils is shifted in position from the fifth group of coils by 60 degrees in the circumferential direction (in the example illustrated in FIGS. 19, 20A, and 20B, clockwise). In other words, the slot having slot identification number 26 shifted from the slot having slot identification number 21, that is, from the position of the start of winding of the fifth group of coils by a slot pitch of 5 (60 degrees) is set as the position of the start of winding of the sixth group of coils. When winding is performed around the slots from this position of the start of winding at slot pitches of “3, 3, 4, 4, 4, 4, 4, 3, 3,” the slot having identification number 28 shifted from that having identification number 23, that is, from the position of the end of winding of the fifth group of coils by a slot pitch of 5 is set as the position of the end of winding of the sixth group of coils. The thus disposed sixth group of coils can be used as the remaining half of the third-phase windings (e.g., W-phase windings).

For example, the first group of coils forms a half of first-phase windings (e.g., U-phase windings), and the fourth group of coils forms the remaining half of the first-phase windings (e.g., U-phase windings). First-phase windings (e.g., U-phase windings) in the stator 1 can be formed by connecting the first group of coils and the fourth group of coils to each other via a crossover line. The second group of coils forms a half of second-phase windings (e.g., V-phase windings), and the fifth group of coils forms the remaining half of the second-phase windings (e.g., V-phase windings). Second-phase windings (e.g., V-phase windings) in the stator 1 can be formed by connecting the second group of coils and the fifth group of coils to each other via a crossover line. The third group of coils forms a half of third-phase windings (e.g., W-phase windings), and the sixth group of coils forms the remaining half of the third-phase windings (e.g., W-phase windings). Third-phase windings (e.g., W-phase windings) in the stator 1 can be formed by connecting the third group of coils and the sixth group of coils to each other via a crossover line. In this manner, a three-phase winding can be formed by individually disposing the first to sixth groups of coils in the slots, and connecting the individual groups of coils to each other via crossover lines in the above-mentioned way.

The 8-pole, 30-slot three-phase AC motor includes the stator 1 described above, and a rotor facing the stator 1 in the radial direction.

The rotational symmetry of the arrangement of groups of coils that holds in a stator for a fractional-slot three-phase AC motor in which the number of poles 2P is an even multiple of 2 (i.e., the number of pole pairs P is an even number) will be described below.

When the number of poles on the rotor is an even multiple of 2 (i.e., the number of pole pairs is an even number), rotational symmetry holds for the arrangement of the six groups of coils. In the 8-pole, 30-slot three-phase AC motor illustrated in FIGS. 19 to 24, since the number of poles of 8 is four times 2 (i.e., an even multiple of 2), rotational symmetry holds.

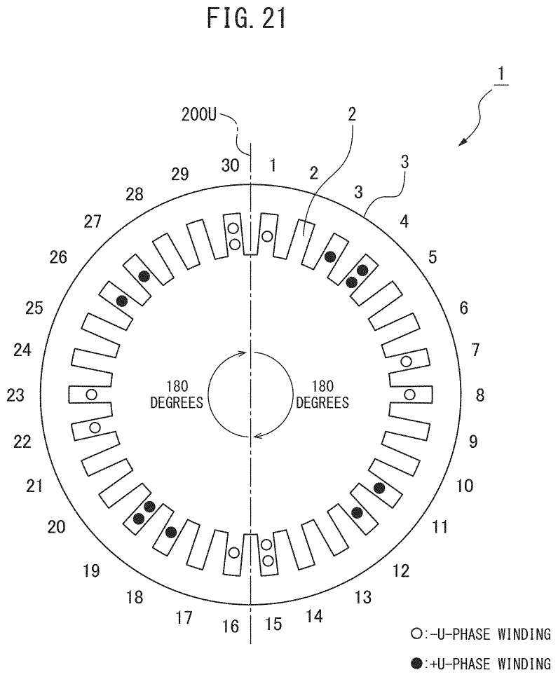

FIG. 21 is a sectional view for explaining the rotational symmetry of the winding arrangement in the 8-pole, 30-slot three-phase AC motor according to the embodiment of the present disclosure. Although the rotational symmetry of the arrangements of −U-phase windings and +U-phase windings will be described herein, the same applies to a set of −V-phase windings and +V-phase windings, and a set of −W-phase windings and +W-phase windings. Referring to FIG. 21, white circles indicate −U-phase windings, and black circles indicate +U-phase windings.

In, e.g., the 8-pole, 30-slot three-phase AC motor, −U-phase windings are disposed in 1.25(=30/8/3) slots per pole per phase. Since 1.25 slots are used per pole per phase, the windings are embedded in slots corresponding to one layer at six positions, and the windings are embedded in slots corresponding to two layers at two positions. In other words, −U-phase windings are embedded in 15 slots for eight pole pairs. The same applies to +U-phase windings, which are disposed in 1.25 slots per pole per phase, and, therefore, the windings are embedded in slots corresponding to one layer at six positions, and the windings are embedded in slots corresponding to two layers at two positions. A set of −U-phase coils and +U-phase coils can be divided into two equal parts with an axis 200U as a boundary, as illustrated in FIG. 21. This is also because the 8-pole, 30-slot three-phase AC motor is equivalent to two periods of a 4-pole, 15-slot configuration (the slots having slot identification numbers 1 to 15 and the slots having slot identification numbers 16 to 30 have the same winding arrangement). In this manner, the 8-pole, 30-slot three-phase AC motor has two-fold rotational symmetry. Since all the six phase belts: −U, +U, −V, +V, −W, and +W have two-fold rotational symmetry, each of these six phase belts always has an even number of windings. Therefore, by appropriately determining a combination of negative windings (− windings) and positive windings (+ windings) for each phase, the negative windings (− windings) and the positive windings (+ windings) of each phase can be divided into two groups of coils while maintaining rotational symmetry. In, e.g., the 8-pole, 30-slot three-phase AC motor, the −U-phase windings and the +U-phase windings in FIG. 21B form the first group of coils and the fourth group of coils in FIGS. 20A and 20B. Similarly, the −V-phase windings and the +V-phase windings can form the second group of coils and the fifth group of coils, and the −W-phase windings and the +W-phase windings can form the third group of coils and the sixth group of coils.

A stator in an 8-pole, 36-slot three-phase AC motor will be described below.

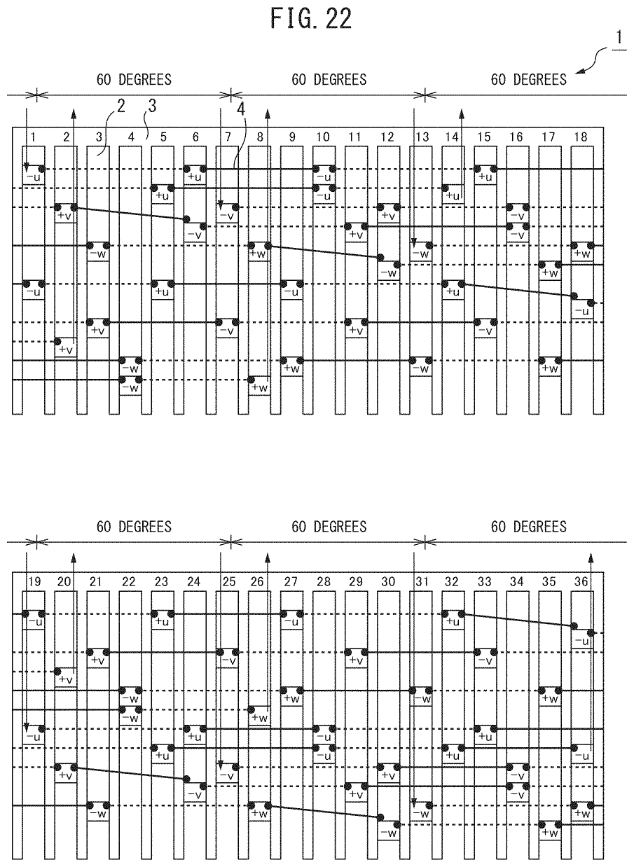

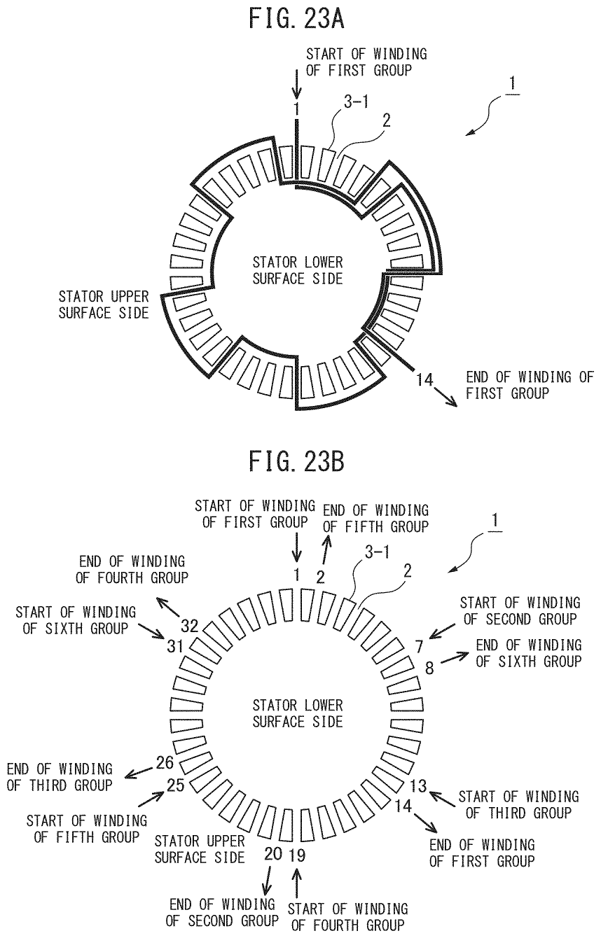

FIG. 22 is a developed sectional view illustrating the coil arrangement of a stator in an 8-pole, 36-slot three-phase AC motor according to an embodiment of the present disclosure. Referring to FIG. 22, a coil arrangement corresponding to the 36 slots is illustrated in two rows (i.e., slot identification numbers 1 to 18 and slot identification numbers 19 to 36), for the sake of drawing simplicity and clarity. FIG. 23A is a diagram illustrating a schematic circle representing the coil arrangement of groups of coils in the stator illustrated in FIG. 22, and depicts the arrangement of a first group of coils. FIG. 23B is a diagram illustrating a schematic circle representing the coil arrangement of the groups of coils in the stator illustrated in FIG. 22, and depicts a schematic circle representing the positions of the start and the start of winding of the groups of coils in the stator.

In the 8-pole, 36-slot three-phase AC motor, since the value obtained by dividing the number of slots of 36 by the number of poles of 8 is 4.5, the motor satisfies the requirement “the number of slots is larger than 1.5 times the number of poles.” In addition, since 9/2 taken as the value obtained by dividing the number of slots of 36 by the number of poles of 8 is an irreducible fraction, the motor can be said to be of the fractional slot type.

In the 8-pole, 36-slot three-phase AC motor, since the quotient, that is, the decimal integer part of the value obtained by dividing the number of slots of 36 by the number of poles of 8 is 4, the stator 1 is provided with six groups of coils formed by the coils 4 arranged in the slots 2 by wave winding at a slot pitch of 4 or 5(=4+1). The six groups of coils are shifted in position from each other by 60 degrees in the circumferential direction.

The 8-pole, 36-slot three-phase AC motor can be provided with groups of coils formed by coils of wave winding arranged in the slots 2 at a slot pitch of 4 or a slot pitch of 5. For example, coil ends corresponding to a slot pitch of 4 or a slot pitch of 5 are exposed on the stator upper surface side, and coil ends corresponding to a slot pitch of 4 or a slot pitch of 5 are exposed on the stator lower surface side.

As illustrated in FIGS. 22, 23A, and 23B, in the first group of coils, the coil is inserted from the stator upper surface side to the stator lower surface side of the slot having slot identification number 1, and inserted from the stator lower surface side to the stator upper surface side of the slot having slot identification number 6 shifted from that having slot identification number 2 by a slot pitch of 5. The coil is further inserted from the stator upper surface side to the stator lower surface side of the slot having slot identification number 10 shifted from that having slot identification number 6 by a slot pitch of 4, and inserted from the stator lower surface side to the stator upper surface side of the slot having slot identification number 15 shifted from that having slot identification number 10 by a slot pitch of 5. The coil is further inserted from the stator upper surface side to the stator lower surface side of the slot having slot identification number 19 shifted from that having slot identification number 15 by a slot pitch of 4, and inserted from the stator lower surface side to the stator upper surface side of the slot having slot identification number 23 shifted from that having slot identification number 19 by a slot pitch of 4. The coil is further inserted from the stator upper surface side to the stator lower surface side of the slot having slot identification number 27 shifted from that having slot identification number 23 by a slot pitch of 4, and inserted from the stator lower surface side to the stator upper surface side of the slot having slot identification number 32 shifted from that having slot identification number 27 by a slot pitch of 5. The coil is further inserted from the stator upper surface side to the stator lower surface side of the slot having slot identification number 36 shifted from that having slot identification number 32 by a slot pitch of 4, and inserted from the stator lower surface side to the stator upper surface side of the slot having slot identification number 5 shifted from that having slot identification number 36 by a slot pitch of 5. The coil is further inserted from the stator upper surface side to the stator lower surface side of the slot having slot identification number 10 shifted from that having slot identification number 5 by a slot pitch of 5, and inserted from the stator lower surface side to the stator upper surface side of the slot having slot identification number 14 shifted from that having slot identification number 10 by a slot pitch of 4. In this manner, in the first group of coils, the slot having slot identification number 1 is set as the position of the start of winding, and the slot having slot identification number 14 shifted from the slot having slot identification number 1 by 360 degrees clockwise plus an amount of 13 slots (130 degrees) clockwise is set as the position of the end of winding. The thus disposed first group of coils can be used as a half of first-phase windings (e.g., U-phase windings).

As described above, for the first group of coils, coils of wave winding are disposed at slot pitches of “5, 4, 5, 4, 4, 4, 5, 4, 5, 5, 4.” The second to sixth groups of coils are also formed by coils of wave winding having the same or similar slot pitches.

As illustrated in FIGS. 22, 23A, and 23B, the second group of coils is shifted in position from the first group of coils by 60 degrees in the circumferential direction (in the example illustrated in FIGS. 22, 23A, and 23B, clockwise). In other words, the slot having slot identification number 7 shifted from the slot having slot identification number 1, that is, from the position of the start of winding of the first group of coils by a slot pitch of 6 (60 degrees) is set as the position of the start of winding of the second group of coils. When winding is performed around the slots from this position of the start of winding at slot pitches of “5, 4, 5, 4, 4, 4, 5, 4, 5, 5, 4,” the slot having identification number 20 shifted from that having identification number 14, that is, from the position of the end of winding of the first group of coils by a slot pitch of 6 is set as the position of the end of winding of the second group of coils. The thus disposed second group of coils can be used as a half of second-phase windings (e.g., V-phase windings).

As illustrated in FIGS. 22, 23A, and 23B, the third group of coils is shifted in position from the second group of coils by 60 degrees in the circumferential direction (in the example illustrated in FIGS. 22, 23A, and 23B, clockwise). In other words, the slot having slot identification number 13 shifted from the slot having slot identification number 7, that is, from the position of the start of winding of the second group of coils by a slot pitch of 6 (60 degrees) is set as the position of the start of winding of the third group of coils. When winding is performed around the slots from this position of the start of winding at slot pitches of “5, 4, 5, 4, 4, 4, 5, 4, 5, 5, 4,” the slot having identification number 26 shifted from that having identification number 20, that is, from the position of the end of winding of the second group of coils by a slot pitch of 6 is set as the position of the end of winding of the third group of coils. The thus disposed third group of coils can be used as a half of third-phase windings (e.g., W-phase windings).

As illustrated in FIGS. 22, 23A, and 23B, the fourth group of coils is shifted in position from the third group of coils by 60 degrees in the circumferential direction (in the example illustrated in FIGS. 22, 23A, and 23B, clockwise). In other words, the slot having slot identification number 19 shifted from the slot having slot identification number 13, that is, from the position of the start of winding of the third group of coils by a slot pitch of 6 (60 degrees) is set as the position of the start of winding of the fourth group of coils. When winding is performed around the slots from this position of the start of winding at slot pitches of “5, 4, 5, 4, 4, 4, 5, 4, 5, 5, 4,” the slot having identification number 32 shifted from that having identification number 26, that is, from the position of the end of winding of the third group of coils by a slot pitch of 6 is set as the position of the end of winding of the fourth group of coils. The thus disposed fourth group of coils can be used as the remaining half of the first-phase windings (e.g., U-phase windings).

As illustrated in FIGS. 22, 23A, and 23B, the fifth group of coils is shifted in position from the fourth group of coils by 60 degrees in the circumferential direction (in the example illustrated in FIGS. 22, 23A, and 23B, clockwise). In other words, the slot having slot identification number 25 shifted from the slot having slot identification number 19, that is, from the position of the start of winding of the fourth group of coils by a slot pitch of 6 (60 degrees) is set as the position of the start of winding of the fifth group of coils. When winding is performed around the slots from this position of the start of winding at slot pitches of “5, 4, 5, 4, 4, 4, 5, 4, 5, 5, 4,” the slot having identification number 2 shifted from that having identification number 32, that is, from the position of the end of winding of the fourth group of coils by a slot pitch of 6 is set as the position of the end of winding of the fifth group of coils. The thus disposed fifth group of coils can be used as the remaining half of the second-phase windings (e.g., V-phase windings).

As illustrated in FIGS. 22, 23A, and 23B, the sixth group of coils is shifted in position from the fifth group of coils by 60 degrees in the circumferential direction (in the example illustrated in FIGS. 22, 23A, and 23B, clockwise). In other words, the slot having slot identification number 31 shifted from the slot having slot identification number 25, that is, from the position of the start of winding of the fifth group of coils by a slot pitch of 6 (60 degrees) is set as the position of the start of winding of the sixth group of coils. When winding is performed around the slots from this position of the start of winding at slot pitches of “5, 4, 5, 4, 4, 4, 5, 4, 5, 5, 4,” the slot having identification number 8 shifted from that having identification number 2, that is, from the position of the end of winding of the fifth group of coils by a slot pitch of 6 is set as the position of the end of winding of the sixth group of coils. The thus disposed sixth group of coils can be used as the remaining half of the third-phase windings (e.g., W-phase windings).

For example, the first group of coils forms a half of first-phase windings (e.g., U-phase windings), and the fourth group of coils forms the remaining half of the first-phase windings (e.g., U-phase windings). First-phase windings (e.g., U-phase windings) in the stator 1 can be formed by connecting the first group of coils and the fourth group of coils to each other via a crossover line. The second group of coils forms a half of second-phase windings (e.g., V-phase windings), and the fifth group of coils forms the remaining half of the second-phase windings (e.g., V-phase windings). Second-phase windings (e.g., V-phase windings) in the stator 1 can be formed by connecting the second group of coils and the fifth group of coils to each other via a crossover line. The third group of coils forms a half of third-phase windings (e.g., W-phase windings), and the sixth group of coils forms the remaining half of the third-phase windings (e.g., W-phase windings). Third-phase windings (e.g., W-phase windings) in the stator 1 can be formed by connecting the third group of coils and the sixth group of coils to each other via a crossover line. In this manner, a three-phase winding can be formed by individually disposing the first to sixth groups of coils in the slots, and connecting the individual groups of coils to each other via crossover lines in the above-mentioned way.

In the 8-pole, 36-slot three-phase AC motor as well, the first to sixth groups of coils may be provided as a plurality of first groups of coils to a plurality of sixth groups of coils, respectively, to form a three-phase winding. Further, a three-phase winding may be formed by disposing one winding in the slots in a pattern drawn with a single line, cutting the winding at positions to individually segment the first to sixth groups of coils to form the first to sixth groups of coils, and then connecting the individual groups of coils to each other via crossover lines.

The 8-pole, 36-slot three-phase AC motor includes the stator 1 described above, and a rotor facing the stator 1 in the radial direction.

In the 8-pole, 36-slot three-phase AC motor, since the number of poles of 8 is four times 2 (i.e., an even multiple of 2), rotational symmetry holds.

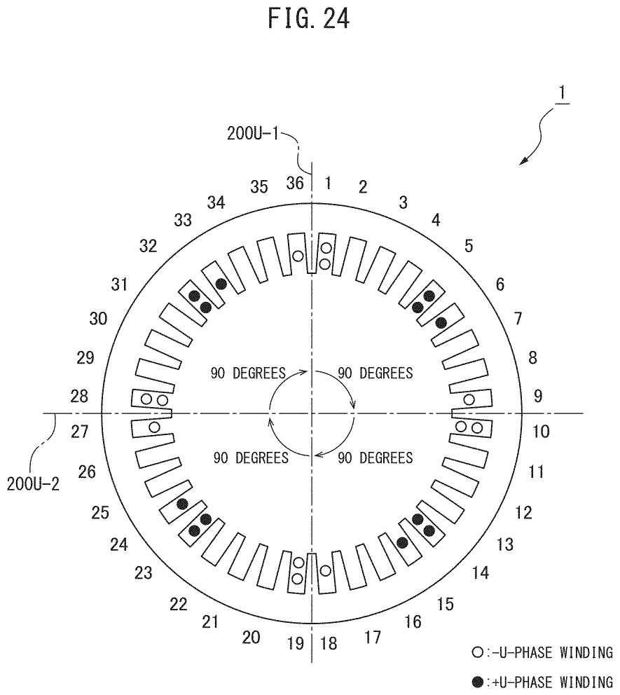

FIG. 24 is a sectional view for explaining the rotational symmetry of the winding arrangement in the 8-pole, 36-slot three-phase AC motor according to the embodiment of the present disclosure. Although the rotational symmetry of the arrangements of −U-phase windings and +U-phase windings will be described herein, the same applies to a set of −V-phase windings and +V-phase windings, and a set of −W-phase windings and +W-phase windings. Referring to FIG. 24, white circles indicate −U-phase windings, and black circles indicate +U-phase windings.

In, e.g., the 8-pole, 36-slot three-phase AC motor, −U-phase windings are disposed in 1.5(=36/8/3) slots per pole per phase. Since 1.5 slots are used per pole per phase, the windings are embedded in slots corresponding to one layer at four positions, and the windings are embedded in slots corresponding to two layers at four positions. The same applies to +U-phase windings, which are disposed in 1.5 slots per pole per phase, and, therefore, the windings are embedded in slots corresponding to one layer at four positions, and the windings are embedded in slots corresponding to two layers at four positions. A set of −U-phase coils and +U-phase coils can be divided into four equal parts with two axes 200U-1 and 200U-2 as boundaries, as illustrated in FIG. 24. This is also because the 8-pole, 36-slot three-phase AC motor is equivalent to two periods of a 2-pole, 9-slot configuration (the slots having slot identification numbers 1 to 9, the slots having slot identification numbers 10 to 18, the slots having slot identification numbers 19 to 27, and the slots having slot identification numbers 27 to 36 have the same winding arrangement). In this manner, the 8-pole, 36-slot three-phase AC motor has four-fold rotational symmetry. Since all the six phase belts: −U, +U, −V, +V, −W, and +W have four-fold rotational symmetry, each of these six phase belts always has an even number of windings. Therefore, by appropriately determining a combination of negative windings (− windings) and positive windings (+ windings) for each phase, the negative windings (− windings) and the positive windings (+ windings) of each phase can be divided into two groups of coils while maintaining rotational symmetry. In, e.g., the 8-pole, 36-slot three-phase AC motor, the −U-phase windings and the +U-phase windings in FIG. 24 form the first group of coils and the fourth group of coils in FIG. 23B. Similarly, the −V-phase windings and the +V-phase windings can form the second group of coils and the fifth group of coils, and the −W-phase windings and the +W-phase windings can form the third group of coils and the sixth group of coils.

An embodiment in which coils of wave winding are disposed in the slots to alternately repeat a slot pitch of X and a slot pitch of X+1 in a pattern drawn with a single line will be described in more detail below. The quotient, that is, the decimal integer part of the value obtained by dividing the number of slots 6N by the number of poles 2P is defined as X (X is a positive integer).

As described above, in, e.g., the 10-pole, 36-slot three-phase AC motor and the 10-pole, 24-slot three-phase AC motor, coils of wave winding can be disposed in the slots to alternately repeat a slot pitch of X and a slot pitch of X+1 in a pattern drawn with a single line. When the arrangement of windings of all the three phases can be completed upon the formation of six groups of coils by disposing coils of wave winding in the slots by an integer number of operations for alternately repeating a slot pitch of X and a slot pitch of X+1 in a pattern drawn with a single line, since wave winding of the same shape is formed continuously with a period corresponding to a slot pitch of 2X+1(=X+X+1), the manufacture of a stator is facilitated.

Under the condition that the stator “includes six groups of coils, and the six groups of coils are shifted in position from each other by 60 degrees in the circumferential direction” as a feature of the present invention, the relationship between the number of poles and the number of slots for allowing coils of wave winding to be disposed in the slots to alternately repeat a slot pitch of X and a slot pitch of X+1 in a pattern drawn with a single line is as follows.

Letting 6N (N is a positive integer) be the number of slots, and 2P (P is a positive integer) be the number of poles, and when the value obtained by dividing the number of slots 6N by the number of poles 2P takes no integer, the quotient, that is, the decimal integer part of the “value obtained by dividing the number of slots 6N by the number of poles 2P” is defined as X (X is a positive integer). A necessary and sufficient condition for forming six groups of coils by disposing coils of wave winding in the slots by an integer number of operations for alternately repeating a slot pitch of X and a slot pitch of X+1 in a pattern drawn with a single line is expressed as the following condition:

2X+1 and 3N are relatively prime. In other words, 2X+1 and 3N have no common divisor other than 1. Condition (I):

Since 2X+1 is an odd number, when condition (I) holds, 2X+1 and 6N are relatively prime. Therefore, since the least common multiple of 2X+1 and 6N is “(2X+1)×6N,” when the coil is disposed at a slot pitch of 2X+1, the winding returns to the original position after 6N repetitions of 2X+1. Because of a period of the 6N repetitions, a period corresponding to a slot pitch of 2X+1 can be divided into six parts. To set the number of slots 6N equal to (2X+1)×6N, since 6N may be preferably multiplied by (2X+1), wave winding is performed around all the slots to span 360 degrees (2X+1) times. The position at which winding has been performed around the slots by Z (Z is a positive integer) repetitions of a slot pitch of 2X+1 is equal to the remainder obtained by dividing “(2X+1)×Z” by 6N. The remainder obtained by dividing the value of “(2X+1)×Z” by 6N takes any values of 0 to 6N−1, and when Z takes each of the values of 0 to 6N−1, this remainder takes any values of 0 to 6N−1 once each. Therefore, when the coil is wound around the slots by 6N repetitions of a slot pitch of 2X+1, it is disposed in every slot once each.

It can be determined whether condition (I) is satisfied, based on the number of poles 2P and the number of slots 6N.

An 8-pole, 18-slot three-phase AC motor will be described below as a first example. Since P=4, N=3, and 6N/(2P)=18/8=2.25, X=2. Hence, 2X+1=2×2+1=5, and 3N=9. Since 5 and 9 are relatively prime, the motor satisfies condition (I). When winding is performed alternately at a slot pitch of 2 and a slot pitch of 3, windings are disposed around the slots by wave winding with a period corresponding to a slot pitch of 5.

In an arithmetic progression having a first term of 1 and a common difference of 5(=2X+1), a progression in which 18(=6N) is subtracted from every term that exceeds 18(=6N) will be considered herein. The respective terms are arranged in sequence as “1, 6, 11, 16, 3, 8, 13, 18, 5, 10, 15, 2, 7, 12, 17, 4, 9, 14, 1, . . . ,” and the value returns to the first term of 1 in the 19th term of the progression, and, accordingly, the same progression is repeated subsequently. In this case, from the first term to the 18th term of the progression, different values of 1 to 18 always appear once. This progression having the first term to the 18th term is defined as progression 1. A progression which has each term obtained by adding 2(=X) to the corresponding term of progression 1, and in which 18(=6N) is subtracted from every term that exceeds 18(=6N) is expressed as “3, 8, 13, 18, 5, 10, 15, 2, 7, 12, 17, 4, 9, 14, 1, 6, 11, 16, 3.” This progression is defined as progression 2. Progression 2 also consists of 18 terms and includes different values of 1 to 18 each appearing once, like progression 1. The terms of progressions 1 and 2 are arranged with each term of the above-mentioned progression 2 being inserted one by one between the corresponding odd term and even term of the above-mentioned progression 1 as “1, 3, 6, 8, 11, 13, 16, 18, 3, 5, 8, 10, 13, 15, 18, 2, 5, 7, 10, 12, 15, 17, 2, 4, 7, 9, 12, 14, 17, 1, 4, 6, 9, 11, 14, 16.” This progression is defined as progression 3. In progression 3, each odd term and its succeeding term have a difference of 2(=X), and each even term and its succeeding term have a difference of 3(=X+1). Progression 3 consists of 36 terms(=6N×2) and always includes different values of 1 to 18 each appearing twice. Progression 3 is divided into sets of three terms as “1, 3, 6,” “8, 11, 13,” “16, 18, 3,” “5, 8, 10,” “13, 15, 18,” “2, 5, 7,” “10, 12, 15,” “17, 2, 4,” “7, 9, 12,” “14, 17, 1,” “4, 6, 9,” and “11, 14, 16.” In other words, progression 3 can be split into six progressions.

Upon association of each value of progression 3 with the corresponding slot identification number of the stator of the 8-pole, 18-slot three-phase AC motor, when these values are assumed to represent slots in which windings are disposed by wave winding, the six progressions obtained by splitting progression 3 can be determined as the identification numbers of slots around which six groups of coils are wound by wave winding.

The 8-pole, 30-slot three-phase AC motor illustrated in FIGS. 19, 20A, and 20B will be described below as a second example. In this case, since P=4, N=5, and X=3, 2X+1=2×3+1=7, and 3N=15. Since 7 and 15 are relatively prime, the motor satisfies condition (I). When winding is performed alternately at a slot pitch of 3 and a slot pitch of 4, windings are disposed around the slots by wave winding with a period corresponding to a slot pitch of 7.

In an arithmetic progression having a first term of 1 and a common difference of 7(=2X+1), a progression in which 30(=6N) is subtracted from every term that exceeds 30(=6N) will be considered herein. The respective terms are arranged in sequence as “1, 8, 15, 22, 29, 6, 13, 20, 27, 4, 11, 18, 25, 2, 9, 16, 23, 30, 7, 14, 21, 28, 5, 12, 19, 26, 3, 10, 17, 24, 1, . . . .” The value returns to the first term of 1 in the 31st term of the progression, and, accordingly, the same progression is repeated subsequently. In this case, from the first term to the 30th term of the progression, different values of 1 to 30 always appear once. This progression having the first term to the 30th term is defined as progression 4. A progression which has each term obtained by adding 3(=X) to the corresponding term of progression 4, and in which 30(=6N) is subtracted from every term that exceeds 30(=6N) is expressed as “4, 11, 18, 25, 2, 9, 16, 23, 30, 7, 14, 21, 28, 5, 12, 19, 26, 3, 10, 17, 24, 1, 8, 15, 22, 29, 6, 13, 20, 27.” This progression is defined as progression 5. Progression 5 also consists of 30 terms and includes different values of 1 to 30 each appearing once, like progression 4. The terms of progressions 4 and 5 are arranged with each term of the above-mentioned progression 5 being inserted one by one between the corresponding odd term and even term of the above-mentioned progression 4 as “1, 4, 8, 11, 15, 18, 22, 25, 29, 2, 6, 9, 13, 16, 20, 23, 27, 30, 4, 7, 11, 14, 18, 21, 25, 28, 2, 5, 9, 12, 16, 19, 23, 26, 30, 3, 7, 10, 14, 17, 21, 24, 28, 1, 5, 8, 12, 15, 19, 22, 26, 29, 3, 6, 10, 13, 17, 20, 24, 27.” This progression is defined as progression 6. In progression 6, each odd term and its succeeding even term have a difference of 3(=X), and each even term and its succeeding odd term have a difference of 4(=X+1). Progression 6 consists of 60 terms(=6N×2) and always includes different values of 1 to 30 each appearing twice. Progression 6 is divided into sets of 12 terms as “1, 4, 8, 11, 15, 18, 22, 25, 29, 2, 6, 9,” “13, 16, 20, 23, 27, 30, 4, 7, 11, 14, 18, 21,” “25, 28, 2, 5, 9, 12, 16, 19, 23, 26, 30, 3,” “7, 10, 14, 17, 21, 24, 28, 1, 5, 8, 12, 15,” and “19, 22, 26, 29, 3, 6, 10, 13, 17, 20, 24, 27.” In other words, progression 6 can be split into six progressions.

Upon association of each value of progression 6 with the corresponding slot identification number of the stator of the 8-pole, 30-slot three-phase AC motor, when these values are assumed to represent slots in which windings are disposed by wave winding, the six progressions obtained by splitting progression 6 can be determined to represent slots through which six groups of coils wound by wave winding pass.

The slot arrangement described above can be implemented by satisfying condition (I) by the 8-pole, 30-slot three-phase AC motor. Independently of such a slot arrangement, for the 8-pole, 30-slot three-phase AC motor, the case where winding is performed around the slots by wave winding at slot pitches of “3, 3, 4, 4, 4, 4, 4, 3, 3” from the position of the start of winding of any group of coils has also been described, as already illustrated in FIGS. 19, 20A, and 20B. The slot arrangement illustrated in FIGS. 19, 20A, and 20B can be implemented because the 8-pole, 30-slot three-phase AC motor has rotational symmetry regarding the winding arrangement. For, e.g., the stator of the 8-pole, 30-slot three-phase AC motor, it may be preferably determined as appropriate whether the slot arrangement according to the above-mentioned second example or the slot arrangement illustrated in FIGS. 19, 20A, and 20B is used, in accordance with the design details of the three-phase AC motor.

The slot arrangement of a stator for a three-phase AC motor that does not satisfy condition (I) will be described below as a third example. The 8-pole, 36-slot three-phase AC motor illustrated in FIGS. 22, 23A, and 23B, for example, does not satisfy condition (I). More specifically, since P=4, N=6, and 6N/(2P)=36/8=4.5, X=4. 2X+1=2×4+1=9, and 3N=18. Since 9 and 18 have a greatest common divisor of 9, the motor does not satisfy condition (I). When wave winding is performed alternately at a slot pitch of 4 and a slot pitch of 5, windings are disposed in the slots with a period corresponding to a slot pitch of 9.

In an arithmetic progression having a first term of 1 and a common difference of 9(=2X+1), a progression in which 36(=6N) is subtracted from every term that exceeds 36(=6N) will be considered herein. The respective terms are arranged in sequence as “1, 10, 19, 28, 1, 10, 19, 28, 1, 10, 19, 28, 1, 10, 19, 28, 1, 10, 19, 28, 1, 10, 19, 28, 1, . . . .” This progression having the first term to the 36th term is defined as progression 7. Progression 7 takes a value of 1 in the fifth term, the nineth term, the 13th term, the 17th term, the 21st term, the 25th term, the 29th term, and the 33rd term, and therefore can be said to be a progression having the sequence “1, 10, 19, 28” repeated nine times. A progression which has each term obtained by adding 4(=X) to the corresponding term of progression 7, and in which 36(=6N) is subtracted from every term that exceeds 36(=6N) is expressed as “5, 14, 23, 32, 5, 14, 23, 32, 5, 14, 23, 32, 5, 14, 23, 32, 5, 14, 23, 32, 5, 14, 23, 32, 5, 14, 23, 32, 5, 14, 23, 32, 5, 14, 23, 32.” This progression is defined as progression 8. Progression 8 takes a value of 5 in the fifth term, the nineth term, the 13th term, the 17th term, the 21st term, the 25th term, the 29th term, and the 33rd term, and therefore can be said to be a progression having the sequence “5, 14, 23, 32” repeated nine times. The terms of progressions 7 and 8 are arranged with each term of the above-mentioned progression 8 being inserted one by one between the corresponding odd term and even term of the above-mentioned progression 7 as “1, 5, 10, 14, 19, 23, 28, 32, 1, 5, 10, 14, 19, 23, 28, 32, 1, 5, 10, 14, 19, 23, 28, 32, 1, 5, 10, 14, 19, 23, 28, 32, 1, 5, 10, 14, 19, 23, 28, 32, 1, 5, 10, 14, 19, 23, 28, 32, 1, 5, 10, 14, 19, 23, 28, 32, 1, 5, 10, 14, 19, 23, 28, 32, 1, 5, 10, 14, 19, 23, 28, 32.” This progression is defined as progression 9. In progression 9, each odd term and its succeeding even term have a difference of 4, and each even term and its succeeding odd term have a difference of 5, but the sequence “1, 5, 10, 14, 19, 23, 28, 32” is repeated nine times, and only a series of eight integers of 1, 5, 10, 14, 19, 23, 28, and 32 among integers of 1 to 36 is repeated.

Upon association of each value of progression 9 with the corresponding slot identification number of the stator of the 8-pole, 36-slot three-phase AC motor, when these values are assumed to represent slots in which windings are disposed by wave winding, coils of wave winding to be disposed alternately at a slot pitch of 4 and a slot pitch of 5 are not disposed in all the slots, but they are repeatedly wound around only specific slots. In this manner, if the motor does not satisfy condition (I) for the number of poles and the number of slots, when wave winding is performed alternately at a slot pitch of X and a slot pitch of X+1, wave winding is repeatedly performed around only specific slots, and winding may not be performed around all the slots even by a series of wave winding operations. In such a case, as long as groups of coils are formed at one or more successive slot pitches of X or one or more successive slot pitches of X+1, they can be divided into six groups of coils that can be wound around all the slots, as described with reference to FIGS. 22, 23A, and 23B. The property of allowing such division into six groups of coils is related to the property of having even-fold rotational symmetry.

As described above as the third example, when the motor does not satisfy condition (I), division into six groups of coils can be done by forming groups of coils at a slot pitch of X or a slot pitch of X+1 so that these slot pitches are not always repeated alternately. This is related to the fact that the above-mentioned winding arrangements of the six phase belts have the property of line symmetry or the property of even-fold rotational symmetry.

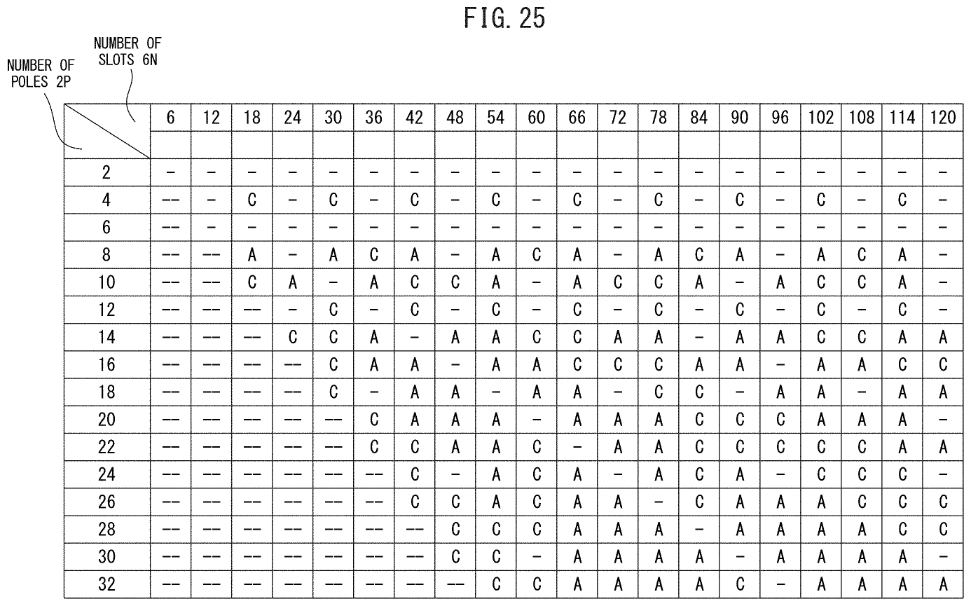

FIG. 25 is a table illustrating the relationship between the number of poles and the number of slots in a three-phase AC motor that can employ the slot arrangement according to any embodiment of the present disclosure. The first column of the table illustrated in FIG. 25 represents the number of poles of the three-phase AC motor, and the first row of this table represents the number of slots (multiples of 6) of the stator of the three-phase AC motor.

In the cells of the table illustrated in FIG. 25, “-” represents a motor in which the value obtained by dividing the number of slots of interest by the number of poles takes an integer. “- -” represents a motor in which the value obtained by dividing the number of slots of interest by the number of poles is smaller than 1.5.

In the cells of the table illustrated in FIG. 25, “C” represents a motor that does not satisfy condition (I), although allowing the configuration of six groups of coils of wave winding having a slot pitch of X and a slot pitch of X+1. In other words, “C” represents a motor in which a slot pitch of X and a slot pitch of X+1 are not always repeated alternately in wave winding of each group of coils. The stator of the 8-pole, 36-slot three-phase AC motor according to the above-mentioned third example, for example, applies to this case.

In the cells of the table illustrated in FIG. 25, “A” represents a motor that satisfies condition (I). In other words, “A” represents a motor that allows the configuration of six groups of coils of wave winding having a slot pitch of X or a slot pitch of X+1, while also allowing a configuration having coils of wave winding disposed alternately at a slot pitch of X and a slot pitch of X+1. The stator of the 8-pole, 18-slot three-phase AC motor according to the above-mentioned first example and the stator of the 8-pole, 30-slot three-phase AC motor according to the above-mentioned second example, for example, apply to this case.

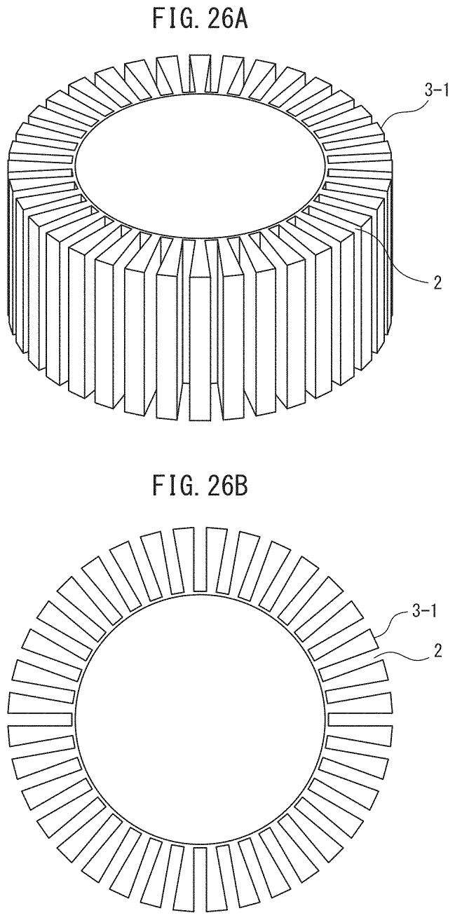

A method for manufacturing a stator for a three-phase AC motor according to an embodiment of the present disclosure will be described below with reference to FIGS. 26A to 32. The following description similarly applies to three-phase AC motors having the above-mentioned respective numbers of poles and the above-mentioned respective numbers of slots.

FIG. 26A is a perspective view illustrating an inner core used in the stator of the three-phase AC motor according to any embodiment of the present disclosure. FIG. 26B is a top view illustrating the inner core used in the stator of the three-phase AC motor according to the embodiment of the present disclosure. An inner core 3-1 provided with slots 2 to open on the outer circumferential side is fabricated first by forming grooves in a cylindrical magnetic material on the outer circumferential side.

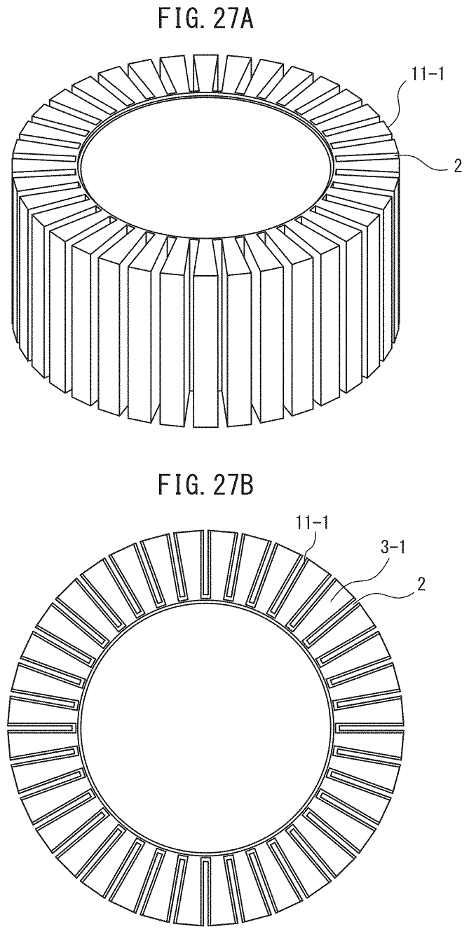

FIG. 27A is a perspective view illustrating the state in which first insulators are mounted on the inner core illustrated in FIGS. 26A and 26B. FIG. 27B is a top view illustrating the state in which the first insulators are mounted on the inner core illustrated in FIGS. 26A and 26B. First insulators 11-1 for insulating the stator and the windings from each other are mounted in the slots 2 of the inner core 3-1. The first insulators 11-1 may be implemented as, e.g., insulating paper mounted in the slots 2, an insulating resin that seals the inner surfaces of the slots 2, or an insulating coating applied to the inner surfaces of the slots 2. FIGS. 27A and 27B illustrate the first insulators 11-1 mounted by resin sealing as an example.

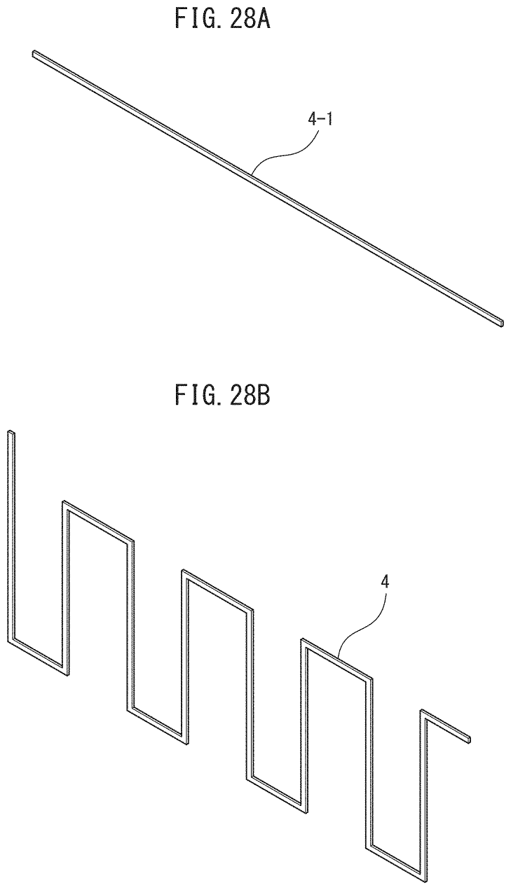

FIG. 28A is a perspective view illustrating a rectangular wire used in the stator of the three-phase AC motor according to any embodiment of the present disclosure, and depicts a wire implemented as a rectangular wire. FIG. 28B is a perspective view illustrating the rectangular wire used in the stator of the three-phase AC motor according to the embodiment of the present disclosure, and depicts a winding wound by wave winding. As the material of a winding, a wire 4-1 implemented as a rectangular wire, as illustrated in FIG. 28A, is shaped into a coil 4 of wave winding, as illustrated in FIG. 28B, so that it can be disposed in the slots 2 at a predetermined slot pitch. In this case, letting X (X is a positive integer) be the quotient, that is, the decimal integer part of the value obtained by dividing the number of slots 6N by the number of poles 2P, the coil 4 is shaped so that it can be disposed in the slots 2 at a slot pitch of X or X+1. In, e.g., the stator of the above-mentioned 10-pole, 36-slot three-phase AC motor, the coil 4 is shaped so that the interval at which it is disposed in the slots 2 alternately repeats a slot pitch of 3 and a slot pitch of 4.

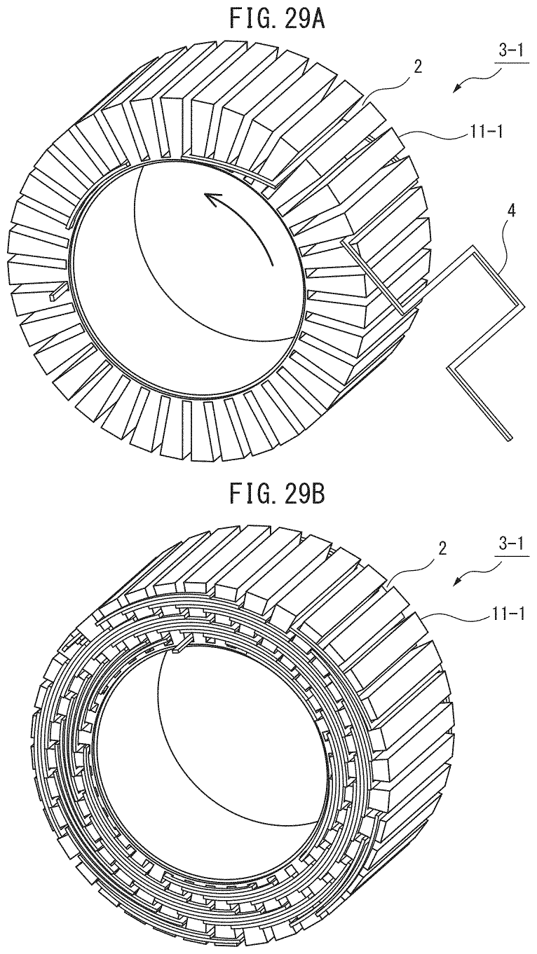

FIG. 29A is a perspective view for explaining processing of disposing the winding wound by wave winding illustrated in FIG. 28B on the inner core mounted with the first insulators illustrated in FIGS. 27A and 27B, and depicts the inner core during the processing of disposing the winding. FIG. 29B is a perspective view for explaining the processing of disposing the winding wound by wave winding illustrated in FIG. 28B on the inner core mounted with the first insulators illustrated in FIGS. 27A and 27B, and depicts the inner core after such windings are disposed. As illustrated in FIG. 29A, the inner core 3-1 after the windings are disposed, as illustrated in FIG. 29B, is obtained by disposing the coil 4 of wave winding in the slots 2 in a pattern drawn with a single line while rotating (in the example illustrated in FIG. 29A, counterclockwise) the inner core 3-1 mounted with the first insulators 11-1.

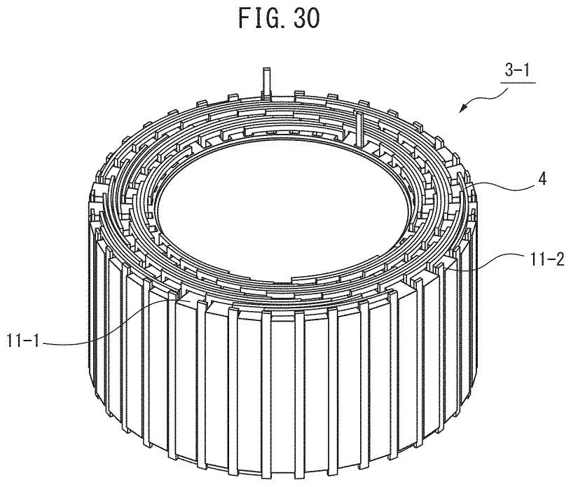

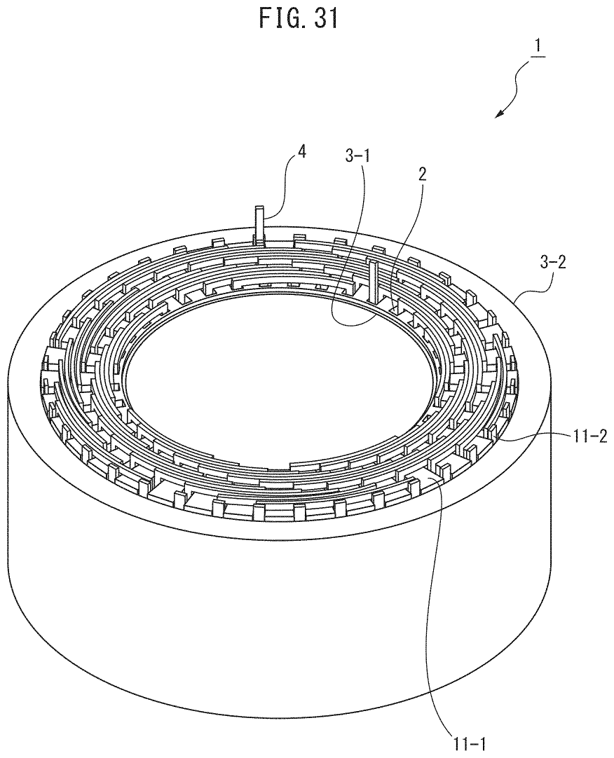

FIG. 30 is a perspective view illustrating the state in which second insulators are mounted on the inner core illustrated in FIGS. 29A and 29B. As illustrated in FIG. 30, second insulators 11-2 are further mounted in the slots 2 of the inner core 3-1, mounted with coils 4 illustrated in FIGS. 29A and 29B, on the outer circumferential side of the coils 4. The second insulators 11-2 may be implemented as, e.g., insulating paper mounted in the slots 2, an insulating resin that seals the inner surfaces of the slots 2, or an insulating coating applied to the inner surfaces of the slots 2.

FIG. 31 is a perspective view illustrating the state in which an outer core is disposed on the outer circumferential side of the inner core illustrated in FIG. 30. An outer core 3-2 is disposed on the outer circumferential side of the inner core 3-1 illustrated in FIG. 30.

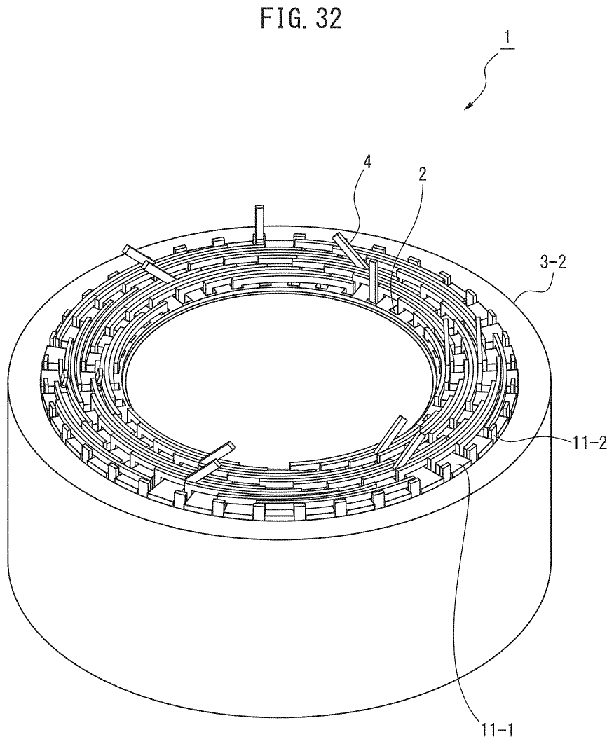

FIG. 32 is a perspective view illustrating a stator obtained by cutting, at predetermined positions, windings arranged in the slots of the inner core illustrated in FIG. 31 in a pattern drawn with a single line, and connecting the windings to each other via crossover lines. The coils 4 disposed in the slots of the inner core in a pattern drawn with a single line can form first to sixth groups of coils by cutting the winding at positions to individually segment the first to sixth groups of coils, as described with reference to FIGS. 11 and 12. After that, a stator 1 is completed by forming a three-phase winding by connecting the individual groups of coils to each other via crossover lines.

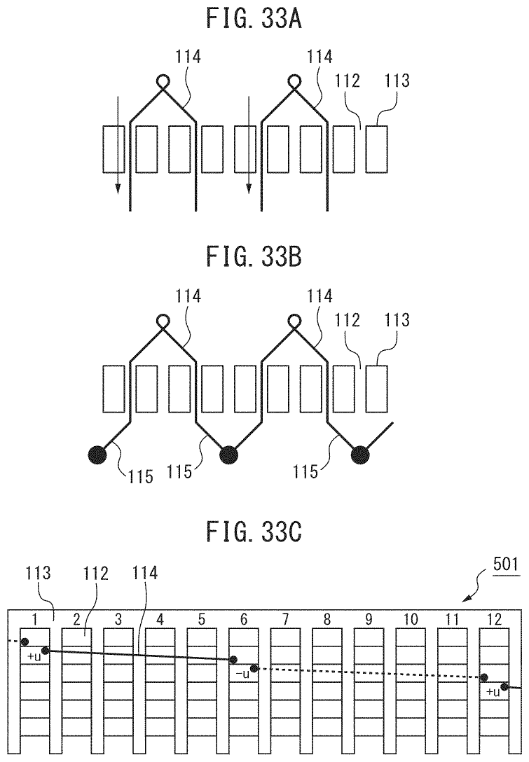

FIGS. 33A to 33C are diagrams illustrating an exemplary conventional winding process in a stator including coils of wave winding of a three-phase AC motor. In the conventional winding process, a plurality of hairpin coils formed by rectangular wires are prepared, and are each shaped into a U shape (denoted by reference numeral 114) and inserted into slots 112, as illustrated in FIG. 33A. Reference numeral 113 denotes a core. Then, the two ends of each coil 114 are bent, and these coils 114 are connected to each other by welding, as illustrated in FIG. 33B. In this manner, in the conventional winding process, since a plurality of coils may be preferably prepared and connected to each other by welding, automatic processing by a machine is disadvantageously relatively complicated. In addition, coils of wave winding in a conventional stator 501 obtained through such a winding process are disposed in the slots 112 with their layers being sequentially shifted in the radial direction, as illustrated in FIG. 33C. For this reason, three-dimensionally shaped coils, like hairpin coils, may be preferably prepared in advance.

In contrast to this, in the method for manufacturing a stator for a three-phase AC motor according to the embodiment of the present disclosure, the shaping of a coil formed by a rectangular wire described with reference to FIGS. 28A and 28B, and the winding process implemented by disposing the coil described with reference to FIGS. 29A and 29B can easily be automated by a machine. Especially since the coil can even be disposed in the slots in a pattern drawn with a single line, easier manufacture is achieved. In addition, since the arrangement of coils of wave winding in the slots 2 involves a shift in the radial direction only for one layer, no three-dimensionally shaped coils, like hairpin coils as used in the conventional techniques, may be preferably prepared, and an easy manufacturing process is therefore attained.

The three-phase AC motors having 10 poles and 36 slots, 10 poles and 24 slots, 8 poles and 30 slots, 8 poles and 36 slots, and 8 poles and 18 slots have been taken as examples above. The present invention is not limited to these examples, and is also applicable to three-phase AC motors having slots and poles in numbers 6N (N is a positive integer) and 2P (P is a positive integer), respectively, other than the above-mentioned numbers, in which the number of slots 6N is larger than 1.5 times the number of poles 2P, and the value obtained by dividing the number of slots 6N by the number of poles 2P takes an irreducible fraction. Combinations of the numbers of poles and the numbers of slots represented by “A” and “C” in FIG. 25 apply to this case. In each drawing, the order of assignment of slot identification numbers is merely an example.

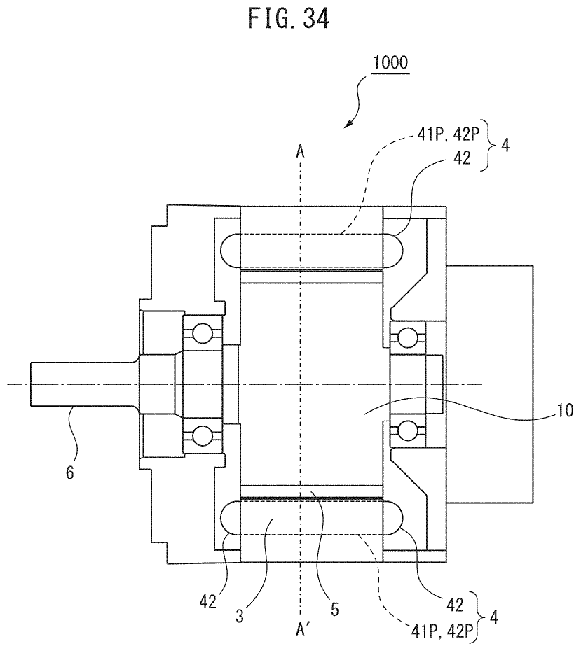

FIG. 34 is a diagram illustrating an exemplary appearance of a three-phase AC motor including the stator according to any embodiment of the present disclosure.

A three-phase AC motor 1000 according to an embodiment of the present disclosure includes the above-mentioned stator 1, and a rotor 10 facing the stator 1 in the radial direction. Referring to FIG. 34, reference numeral 3 denotes a stator core; and 4, coils. Each coil 4 is formed by a positive winding (+ winding) 41P and a negative winding (− winding) 41N accommodated in slots, and coil ends 42 that are not accommodated in the slots. Reference numeral 5 denotes a magnet provided on the rotor 10; and 6, a rotating shaft of the rotor 10.

### REFERENCE SIGNS LIST

1 Stator
2 Slot
3 Stator core
4 Coil
5 Magnet
6 Rotating shaft
10 Rotor
11-1 First insulator
11-2 Second insulator
21 Magnetic pole
41P + (Positive) winding
41N − (Negative) winding
42 Coil end
100U Line dividing all slots of stator into two parts, and axis of line symmetry of U-phase windings
100V Line dividing all slots of stator into two parts, and axis of line symmetry of V-phase windings
100W Line dividing all slots of stator into two parts, and axis of line symmetry of W-phase windings
1000 Three-phase AC motor

1. A stator for a fractional-slot three-phase alternating-current motor in which the number of slots 6N (N is a positive integer) of slots arranged in a circumferential direction is larger than 1.5 times the number of poles 2P (P is a positive integer), and a value obtained by dividing the number of slots 6N by the number of poles 2P takes an irreducible fraction, the stator comprising:
letting X (X is a positive integer) be a quotient of the value obtained by dividing the number of slots 6N by the number of poles 2P,
six groups of coils formed by coils arranged in the slots by wave winding at a slot pitch of one of X and X+1,
wherein the six groups of coils are shifted in position from each other by 60 degrees in a circumferential direction.

2. The stator according to claim 1, wherein
the six groups of coils are formed by a first group of coils to a sixth group of coils,
the second group of coils is shifted in position from the first group of coils by 60 degrees in a circumferential direction,
the third group of coils is shifted in position from the second group of coils by 60 degrees in a direction identical to the circumferential direction,
the fourth group of coils is shifted in position from the third group of coils by 60 degrees in a direction identical to the circumferential direction,
the fifth group of coils is shifted in position from the fourth group of coils by 60 degrees in a direction identical to the circumferential direction, and
the sixth group of coils is shifted in position from the fifth group of coils by 60 degrees in a direction identical to the circumferential direction.

3. The stator according to claim 2, wherein
the first group of coils and the fourth group of coils connected to each other via a crossover line form first-phase windings of a three-phase alternating-current winding,
the second group of coils and the fifth group of coils connected to each other via a crossover line form second-phase windings of a three-phase alternating-current winding, and
the third group of coils and the sixth group of coils connected to each other via a crossover line form third-phase windings of a three-phase alternating-current winding.

4. The stator according to claim 3, wherein a value of the number of pole pairs P defined from the number of poles 2P comprises an odd number.

5. The stator according to claim 4, wherein the first-phase windings in the first group of coils to the sixth group of coils are arranged in line symmetry with respect to a first axis of line symmetry, the second-phase windings in the first group of coils to the sixth group of coils are arranged in line symmetry with respect to a second axis of line symmetry, and the third-phase windings in the first group of coils to the sixth group of coils are arranged in line symmetry with respect to a third axis of line symmetry.

6. The stator according to claim 3, wherein a value of the number of pole pairs P defined from the number of poles 2P comprises an even number.

7. The stator according to claim 6, wherein the first-phase windings in the first group of coils to the sixth group of coils are arranged to have even-fold rotational symmetry, the second-phase windings in the first group of coils to the sixth group of coils are arranged to have even-fold rotational symmetry, and the third-phase windings in the first group of coils to the sixth group of coils are arranged to have even-fold rotational symmetry.

8. The stator according to claim 5, wherein letting X (X is a positive integer) be a quotient of the value obtained by dividing the number of slots 6N (N is an integer) by the number of poles 2P (P is an integer), 2X+1 and 3N are relatively prime.

9-13. (canceled)

14. The stator according to claim 7, wherein letting X (X is a positive integer) be a quotient of the value obtained by dividing the number of slots 6N (N is an integer) by the number of poles 2P (P is an integer), 2X+1 and 3N are relatively prime.

15. The stator according to claim 5, wherein letting X (X is a positive integer) be a quotient of the value obtained by dividing the number of slots 6N (N is an integer) by the number of poles 2P (P is an integer), 2X+1 and 3N have a common divisor greater than 1.

16. The stator according to claim 7, wherein letting X (X is a positive integer) be a quotient of the value obtained by dividing the number of slots 6N (N is an integer) by the number of poles 2P (P is an integer), 2X+1 and 3N have a common divisor greater than 1.

17. A three-phase alternating-current motor comprising:
the stator according to claim 1; and
a rotor facing the stator in a radial direction.

18. A method for manufacturing a stator for a fractional-slot three-phase alternating-current motor in which the number of slots 6N (N is a positive integer) of slots arranged in a circumferential direction is larger than 1.5 times the number of poles 2P (P is a positive integer), and a value obtained by dividing the number of slots 6N by the number of poles 2P takes an irreducible fraction, the method comprising:
a first insulation step of mounting a first insulator in the slots on an inner core in which the slots are formed to open on an outer circumferential side;
a coil group formation step of forming a group of coils of wave winding by inserting a coil shaped into a wave winding shape into the slots, mounted with the first insulator, at a slot pitch of one of X and X+1 when a quotient of the value obtained by dividing the number of slots 6N by the number of poles 2P is defined as X (X is a positive integer);
a second insulation step of mounting a second insulator in the slots on an outer circumferential side of the coil; and
an outer core disposing step of disposing an outer core on an outer circumferential side of the inner core having the slots mounted with the first insulator, the group of coils, and the second insulator.

19. The method for manufacturing a stator according to claim 18, wherein
the group of coils comprises six groups of coils provided in the slots, and
the six groups of coils are shifted in position from each other by 60 degrees in a circumferential direction.

20. The method for manufacturing a stator according to claim 19, wherein letting X (X is a positive integer) be a quotient of the value obtained by dividing the number of slots 6N by the number of poles 2P, each winding shaped into the wave winding shape and inserted into the slots of the stator is wound by wave winding alternately at a slot pitch of X and a slot pitch of X+1.
